(19) United States
(12) Patent Application Publication
(10) Pub. No.: US 2024/0114858 A1
(43) Pub. Date: Apr. 11, 2024

(54) IRRIGATION SYSTEM WITH INTEGRATED DRIVE ASSEMBLY

(71) Applicant: Fieldbot, LLC, Newport Beach, CA (US)

(72) Inventors: Gerald L. Abts, Highlands Ranch, CO (US); Kevin J. Abts, Newport Beach, CA (US); Leslie H. Brunts, Elkhorn, NE (US)

(21) Appl. No.: 18/217,446

(22) Filed: Jun. 30, 2023

Related U.S. Application Data
(60) Provisional application No. 63/358,012, filed on Jul. 1, 2022.

(51) Int. Cl. A01G 25/09

(52) U.S. Cl. CPC A01G 25/092

(57) ABSTRACT

Disclosed are example embodiments of an irrigation system with a plurality of drive tower structures each including a drive beam configured with left and right, right-angle wheel-drive gearbox mounts, each the mount configured with a plurality of bolt holes for attaching a corresponding legacy right-angle wheel-drive gearbox to the mount. The bolt holes being alternatively suitable for attaching a universal inline drive mount adapter, and configured with bolt holes at a first end of the adapter that correspond to bolt holes in the gearbox mounts, each the adapter further configured with bolt holes at a distal end suitable for attaching an inline wheel-drive gearmotor assembly with transfer case.

### CLAIM OF PRIORITY UNDER 35 U.S.C. § 119

The present application for patent claims priority to Provisional Application No. 63/358,012 entitled “IRRIGATION SYSTEM WITH INTEGRATED DRIVE ASSEMBLY” filed Jul. 1, 2022, and assigned to the assignee hereof and hereby expressly incorporated by reference herein.

### TECHNICAL FIELD

The disclosure relates generally to the field of irrigation systems, and specifically and not by way of limitation, some embodiments are related to irrigation systems with an inline drive assembly.

### BACKGROUND

Irrigation systems may have a movement direction over a ground surface of a field, either a forward movement direction or a reverse movement direction, but only one movement direction at any one time. Application of irrigation water to a field using conventional irrigation systems may be facilitated by drive motor speeds and driveline gear reduction ratios that result in relatively slow paces of movement over the ground, e.g., in a range of 1-foot to 10-feet of movement per minute over the ground at an outermost drive tower structure, to apply typical levels of irrigation water. The level of irrigation may be in a range of 0.20-to-2.00-acre inches of water applied to the entire field covered by the irrigation system in a single pass. Such relatively slow paces (speeds) of movement may be delivered by operable sets of driveline components of conventional irrigation systems that function with a stop and start movement of each drive tower structure to maintain intermediate span alignment and to achieve the overall, relatively slow, range of speed of movement of the pace-setting outermost drive tower structure to result in a desired irrigation application—all with abusive, repetitive, stopping and starting of fixed-speed center drive motors with gearbox, each of the center drive motor connected in series with one or more, right-angle worm-drive gearboxes. In application with typical quarter mile long, 120 acre, legacy irrigation systems, such conventional sets of operable driveline components may provide a minimum rotation time for the irrigation system in a range of seven to eighteen-hours, depending on driveline gear ratios, fixed-speed motor RPM speeds, and drive wheel circumferences. Note, maximum speeds of movement for legacy irrigation systems in a range of 8-feet to 20-feet per minute are achievable but may not be suitable for application of certain crop inputs (liquid chemicals, et al) that may be injected into the typically copious water supply or otherwise applied to the field using the irrigation system for timely treatment of insects, funguses and pathogens affecting crops grown in the field under the irrigation system. The limitations may result from both the slow speed of movement, resulting in too much water for proper liquid chemical dilution, and the poor uniformity of fluid application related to the stop and start means of end span pacing and intermediate span alignment.

The alignment methods used with legacy irrigation systems typically require the frequent, repetitive stopping and starting of a plurality of operable center drive motors with gearboxes to maintain alignment among the plurality of intermediate spans, the spans plus an end span making up the linear length of the irrigation system as the irrigation system rotates about the field in a forward or reverse movement direction. Recent developments in irrigation system alignment methods of conventional irrigation systems have disclosed the use of variable-speed motor controllers resulting in variable-speed center drive motors with gearbox, to set a pace and maintain alignment, in place of legacy fixed-speed center drive motors with gearbox that are conventionally controlled on and off to maintain alignment and an overall slower pace of movement.

The adoption of the more recently developed, continuous-move alignment systems (using variable-speed drive motors with motor controller) as disclosed by Krieger (U.S. Pat. No. 6,755,362), Malsam (U.S. Pat. No. 8,948,979) and Abts (U.S. Pat. Nos. 10,130,054 and 10,165,741) has not been widely practiced by irrigators. In addition, recent documents also discloses the use of a center drive motor with an integrated gearbox capable of variable output shaft speeds to achieve variable-speeds of movement of a drive tower structure, all while using a fixed-speed span motor, see Miller, U.S. Pat. No. 10,231,390. In general, some example systems enable continuous movement of intermediate drive tower structures without the abusive on and off cycling of drive motors. These continuous movement alignment systems improve operational reliability by reducing driveline stresses resulting from the conventional on/off cycling of fixed-speed drive motors to maintain alignment and to control the pace (speed) of movement. The continuous-movement alignment systems, herein disclosed by the Krieger, Malsam, and Abts, typically use variable-speed motor controllers to achieve a wide range of motor speeds (RPM) and may also enable faster paces of movement of irrigation systems and better uniformity of liquid applicants than may be feasible with the legacy alignment systems that function with on/off cycling of fixed-speed drive motors. The variable-speed drive motors typically operate at reduced motor torque levels when slowed down or when sped up from an optimal RPM which maintains maximum torque output. A non-limiting list of suitable variable-speed motor types includes a magnetic electric motor, an electrostatic electric motor, a piezoelectric electric motor, a self-commutated DC (direct current) motor, a DC SRM (switched reluctance motor), a DC variable reluctance motor, a stepper motor, an AC (alternating current) asynchronous induction motor, an AC synchronous reluctance motor, or a hub motor with power electronics, digital control and high torque, and the like.

Both the on/off methods and the more recent continuous-movement methods of pacing and aligning of legacy electric center pivots use a final drive gearbox, e.g., a legacy right-angle wheel-drive gearbox with a single-stage, right-angle, worm-gear driving a bull gear at a right-angle to achieve final output shaft speed reduction. This configuration within such legacy right-angle wheel-drive gearboxes provides a nominal 50:1 reduction between an input shaft of the wheel-drive gearbox, driven by a coupler connected to a driveshaft, and a corresponding right-angle bull gear and output shaft connected to a wheel-hub that may be mounted to a drive wheel. Because of the high friction load of the single-stage reduction of the right-angle worm drive gearing, such legacy right-angle wheel-drive gearboxes may provide only 20-40% efficiency of energy-in to energy-out. This low percentage energy conversion of the legacy right-angle wheel-drive gearboxes of conventional irrigation systems are compensated for by using significantly more motor horsepower as compared to horsepower requirements when using inline wheel-drive gearmotor assemblies, as disclosed herein.

### SUMMARY

In one example implementation, an embodiment includes an irrigation system having a movement direction over a ground surface of a field. The irrigation system assembled by the removal of the legacy right-angle wheel-drive gearboxes at corresponding drive tower structures and wherein the drive tower structures each being reconfigured by the mounting of universal inline drive mount adapters.

Disclosed are example embodiments of an irrigation system with a plurality of drive tower structures each including a drive beam configured with left and right, right-angle wheel-drive gearbox mounts, each the mount configured with a plurality of bolt holes for attaching a corresponding legacy right-angle wheel-drive gearbox to the mount. The bolt holes being alternatively suitable for attaching a universal inline drive mount adapter, configured with bolt holes at a first end of the adapter that correspond to bolt holes in the gearbox mounts, each the adapter further configured with bolt holes at a distal end suitable for attaching an inline wheel-drive gearmotor assembly with transfer case.

Disclosed are example embodiments of an irrigation system having a movement direction over a ground surface of a field. The irrigation system including a plurality of pipe spans, each having a longitudinal axis, the plurality of pipe spans each connected at a flex joint that provides fluid connection between a distal end of a span pipe and a first end of a span pipe of adjacent pipe spans, the pipe spans making up a linear length of the irrigation system as the irrigation system rotates about the field in a forward movement direction or reverse movement direction. The irrigation system including a plurality of drive tower structures each supporting and moving a corresponding pipe span, each of the drive tower structures including a drive beam to which an operable set of driveline components are mounted and functional with the driveline components including a motor drop cable providing supply power from a corresponding tower control box to a center drive motor with gearbox, with the center drive motor with gearbox linked by couplers and driveshafts to one or more right-angle wheel-drive gearboxes attached to legacy right-angle wheel-drive gearbox mounts of a drive beam and with an output shaft of the gearboxes connecting to and supporting corresponding wheel mount hubs with studs and bolts, the wheel mount hubs configured for attaching corresponding drive wheel assemblies to a corresponding drive tower structure to support and propel the drive tower structures over the ground surface. The irrigation system assembled by a removal of the legacy right-angle wheel-drive gearboxes at corresponding drive tower structures and wherein the drive tower structures each being reconfigured by mounting of universal inline drive mount adapters each of the adapters being mechanically attached at a first end to a corresponding wheel-drive gearbox mount of a drive beam of a corresponding drive tower structure, the mechanical attachment of the adapter configured by using universal wheel-drive gearbox mounting holes and universal wheel-drive gearbox attaching bolts, the holes conventionally configured into the legacy right-angle wheel-drive gearbox mounts and, a matching set of holes configured into the first end of a universal inline drive mount adapter. The irrigation system wherein each universal drive mount adapter includes a built-in, wheel-hub housing at a distal end, the housing being configured into the adapter by casting or forging the housing with each universal inline drive mount adapter with wheel-hub housing without using bolts. Each built-in, wheel-hub housing being configured with a circular depression positioned at a distal end of the adapter, the circular depression configured to position and support a circular, inline gearbox housing with ring gear of an inline wheel drive gearbox of a bottom separated parallel section of an inline wheel-drive gearmotor assembly, a bottom gearmotor assembly being configured with a corresponding top separated parallel section of an inline wheel-drive gearmotor assembly with motor controller, corresponding top and bottom parallel sections of the gearmotor assembly being configured with a transfer case, the transfer case configured to connect the top parallel section with the bottom parallel section to thereby configure a complete inline wheel-drive gearmotor assembly with transfer case. The irrigation system including an inline motor mount, being configured to receive, position and support the drive motor and motor controller of a corresponding top separated parallel section of an inline wheel-drive gearmotor assembly, the mount being configured to be attached to the distal end of the adapter, a resulting position of the gearmotor assembly with transfer case being configured into a vertical space from below a plane of the bottom of the drive beam to the vertical space above a plane of the top of the drive beam and being configured at a position outboard of the respective end of the drive beam. The irrigation system including each wheel-hub housing of each universal inline drive mount adapter with wheel-hub housing being configured to position and support a final splined output shaft, the output shaft being connected at a splined end to a fourth or final-gear main drive of an inline wheel-drive gearbox, the gearbox being configured as a component of the bottom parallel section of an inline wheel-drive gearmotor assembly, the gearbox further being configured to be propelled by a transfer case output shaft of the transfer case, the output shaft being configured to propel an inline first sun/planet gear cage with shafts of the gearbox, the first gear cage in turn configured to propel an inline second sun/planet gear cage with shafts of the gearbox, the second gear cage in turn configured to propel an inline third sun/planet gear cage with shafts, the third gear cage in turn configured to propel an inline fourth sun/planet gear cage with shafts, the fourth gear cage in turn configured to connect to the splined end of the final splined output shaft of the wheel-hub housing and thereby propel the output shaft. The irrigation system including each final splined output shaft being configured, at an opposite end to the splined end, with a wheel mount hub with studs and bolts, the hub configured for the mounting of a corresponding drive wheel assembly of a corresponding drive tower structure. The irrigation system including each transfer case of the inline wheel-drive gearmotor assembly with transfer case being configured with two or more selectable gear reduction ratios, such gear reduction ratios being selectable by movement of a shift changing fork to configure a sliding splined dog gear from a neutral position to a position when in dog teeth of the sliding splined dog gear engage with a corresponding dog teeth window of an adjacent free-wheeling gear-large or with an adjacent free-wheeling gear-small, to thereby achieve one of two or more selectable gear reduction ratios between a rotating motor shaft and splined motor shaft gear of the top separated parallel section of an inline wheel-drive gearmotor assembly with controller and a rotating transfer case output shaft, the output shaft in turn propelling an inline first sun/planet gear cage with shafts of a corresponding inline wheel-drive gearbox of the bottom separated parallel section of an inline gearmotor assembly.

Disclosed are example embodiments of an irrigation system having a movement direction over a ground surface of a field. The irrigation system including a plurality of pipe spans, each having a longitudinal axis, the plurality of pipe spans each connected at a flex joint that provides fluid connection between a distal end of a span pipe and a first end of a span pipe of adjacent pipe spans, the pipe spans making up the linear length of the irrigation system as it rotates about the field in a forward or reverse movement direction. The irrigation system including a plurality of drive tower structures each supporting and moving a corresponding pipe span, each drive tower structure including a drive beam to which an operable set of driveline components are mounted and functional with the driveline components including a motor drop cable providing supply power from a corresponding tower control box to a center drive motor with gearbox, with the center drive motor with gearbox linked by couplers and driveshafts to one or more right-angle wheel-drive gearboxes attached to legacy right-angle wheel-drive gearbox mounts of a drive beam and with the output shafts of the gearboxes connecting to and supporting corresponding wheel mount hubs with studs and bolts, the wheel mount hubs configured for attaching corresponding drive wheel assemblies to a corresponding drive tower structure to support and propel the drive tower structures over the ground surface. The irrigation system assembled by the removal of the legacy right-angle wheel-drive gearboxes at corresponding drive tower structures and wherein the drive tower structures each being reconfigured by the mounting of universal inline drive mount adapters, each adapter being mechanically attached at a first end to a corresponding wheel-drive gearbox mount of a drive beam of a corresponding drive tower structure, the mechanical attachment of the adapter configured by using universal wheel-drive gearbox mounting holes and universal wheel-drive gearbox attaching bolts, the holes conventionally configured into the legacy right-angle wheel-drive gearbox mounts and a matching set of holes may be configured into a first end of a universal inline drive mount adapter. The irrigation system wherein each legacy right-angle wheel-drive gearbox mount of each drive tower structure may be configured, using some of the systems described herein, to rotate ninety degrees from the position of the drive wheel assemblies required for operating the irrigation system in a field, the ninety-degree rotation, thereby, configuring each drive wheel assembly to align with all drive wheel assemblies for the purpose of towing the irrigation system, the towing may be facilitated by pulling the irrigation system from either a center pivot tower or the outermost drive tower structure. The irrigation system further including a built-in, wheel-hub housing at a distal end, the housing configured with the adapter by casting or forging the housing with each universal inline drive mount adapter with wheel-hub housing without using bolts. The irrigation system, wherein each built-in, wheel-hub housing being configured with a circular depression positioned at a distal end of the adapter, the circular depression being configured to position and support an inline gearbox housing with ring gear of an inline wheel drive gearbox of a bottom separated parallel section of an inline wheel-drive gearmotor assembly, the bottom gearmotor assembly being configured with a corresponding top separated parallel section of an inline wheel-drive gearmotor assembly, the corresponding top and bottom parallel sections of the gearmotor assembly further configured with a transfer case, the transfer case being configured to connect the top parallel section with the bottom parallel section to thereby configure a complete inline wheel-drive gearmotor assembly with transfer case. The irrigation system including an inline motor mount, configured to position and support the drive motor and motor controller of a corresponding top separated parallel section of an inline wheel-drive gearmotor assembly, the mount being configured to be attached to the distal end of the adapter, the resulting position of the gearmotor assembly with transfer case being configured into the vertical space from below the plane of the bottom of the drive beam to the vertical space above the plane of the top of the drive beam and being configured at a position outboard of the respective end of the drive beam. The irrigation system wherein each wheel-hub housing of each universal inline drive mount adapter with wheel-hub housing being configured to position and support a final splined output shaft, the output shaft being connected at a splined end to a fourth (or final) gear-main drive of an inline wheel-drive gearbox, the gearbox being configured as a component of the bottom parallel section of an inline wheel-drive gearmotor assembly, the gearbox being configured to be propelled by a transfer case output shaft of the transfer case, the output shaft being configured to propel an inline first sun/planet gear cage with shafts of the gearbox, the first gear cage in turn configured to propel an inline second sun/planet gear cage with shafts of the gearbox, the second gear cage in turn configured to propel an inline third sun/planet gear cage with shafts, the third gear cage in turn configured to propel an inline fourth sun/planet gear cage with shafts, the fourth gear cage in turn configured to connect to the splined end of the final splined output shaft of the wheel-hub housing and thereby propel the output shaft. The irrigation system wherein each final splined output shaft being configured, at an opposite end to the splined end, with a wheel mount hub with studs and bolts, the hub configured for the mounting of a corresponding drive wheel assembly of a corresponding drive tower structure. The irrigation system wherein each transfer case of the inline wheel-drive gearmotor assembly with transfer case being configured with two or more selectable gear reduction ratios, such gear reduction ratios being selectable by movement of a shift changing fork to configure a sliding splined dog gear from a neutral position to a position that engages either a free-wheeling gear-large or a free-wheeling gear-small, to thereby achieve one of two or more selectable gear reduction ratios between the rotating motor shaft and splined motor shaft gear of the top separated parallel section of an inline wheel-drive gearmotor assembly with controller and the rotating transfer case output shaft, the output shaft in turn propelling an inline first sun/planet gear cage with shafts of a corresponding inline wheel-drive gearbox of the bottom separated parallel section of an inline gearmotor assembly.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 is a perspective view of an example irrigation system in accordance with some aspects of the systems and methods described herein.

FIG. 2 is a perspective view of a conventional drive tower structure with an operable set of legacy driveline components installed onto the drive beam.

FIG. 3 is a perspective end-view of a drive tower structure that includes a drive beam, right-angle wheel-drive gearbox mount, and legacy right-angle wheel-drive gearbox with a drive wheel assembly.

FIG. 4 is a perspective side-view of a drive tower structure and drive beam with the center drive motor with gearbox, the two legacy right-angle wheel-drive gearboxes, and drive wheel assemblies all removed.

FIG. 5A is a perspective view of a universal inline drive mount adapter of an example embodiment illustrating (1) universal wheel-drive gearbox mounting holes at a first end for attaching the inline drive mount adapter to the right-angle wheel-drive gearbox mount and (2) inline wheel-hub housing mounting holes at a distal end for attaching a bolt-on, wheel-hub housing to the universal inline drive mount adapter.

FIG. 5B is a perspective view of another embodiment of a universal inline drive mount adapter illustrating (1) at a first end, universal wheel-drive gearbox mounting holes for attaching the inline drive mount adapter to the right-angle wheel-drive gearbox mount using universal wheel-drive gearbox attaching bolts and (2) at a distal end, inline wheel-hub housing mounting holes for attaching a bolt-on wheel-hub housing to the universal inline drive mount adapter using inline wheel-hub housing attaching bolts.

FIG. 5C are perspective views of a universal inline drive mount adapter with wheel-hub housing, an example embodiment, illustrating at a first end universal wheel-drive gearbox mounting holes for attaching the drive mount adapter with wheel-hub housing to a right-angle wheel-drive gearbox mount and illustrating at a distal end the built-in wheel-hub housing.

FIG. 5D are perspective side-views of a universal inline drive mount adapter with wheel-hub housing of an example embodiment illustrating configurations for adopting the same the drive mount adapter to both the left and right drive beam mounting positions by simple vertical rotation of the universal inline drive mount adapter. The illustrations illustrating the right-angle wheel-drive gearbox mounting holes at a first end and the wheel-hub housing configured with the circular pattern of inline gearbox attaching holes at a distal end. Also illustrated is a final splined output shaft and a wheel mount hub with studs and bolts supported by the wheel-hub housing.

FIG. 6A is a perspective end-view of a drive beam of a drive tower structure that illustrates an attached right-angle wheel-drive gearbox mount with universal wheel-drive gearbox mounting holes.

FIG. 6B is a second perspective end-view of a drive beam of a drive tower structure that includes an attached universal inline drive mount adapter of the second embodiment of an example embodiment with two sets of mounting holes: (1) universal wheel-drive gearbox mounting holes at a first end and (2) inline wheel-hub housing mounting holes configured around a circular hole at a distal end.

FIG. 7A is a side-view of a drive tower structure illustrating the attachment of universal inline drive mount adapters with wheel-hub housing of an example embodiment, the right-angle wheel-drive gearbox mounts at either end (left and right) of the drive beam and illustrating the resulting extended length of the wheelbase of the drive beam.

FIG. 7B is various perspective side-views of drive beams illustrating the attachment of universal inline drive mount adapters with wheel-hub housing of an example embodiment onto the right-angle wheel-drive gearbox mounts at corresponding ends (left and right) of the drive beam and illustrating the resulting extended length of the wheelbase of the drive wheels mounted to the drive beam.

FIG. 8A is an exploded side-view of the components making up an integrated serial section of inline wheel-drive gearmotor assembly with motor controller as the inline wheel-drive gearmotor assembly may be attached to a universal inline wheel-drive mount adapter of an example embodiment with the bolt-on, wheel-hub housing shown with a wheel mount hub with studs and bolts supported by the wheel-hub housing as a separate component and not cast or forged into the universal inline drive mount adapter, the illustration of the components of the inline wheel drive gearbox suitable for illustration of the internal components of the similar inline wheel-drive gearbox configured with the inline wheel-drive gearbox assembly with transfer case.

FIG. 8B is an end-view of an inline gearbox housing with ring gear and an illustration of a profile of an inline sun/planet gear cage with shafts.

FIG. 8C is an end-view of a drive beam of a drive tower structure illustrating placement (mounting) of an integrated serial section of inline wheel-drive gearmotor assembly with motor controller and drive wheel assembly onto a universal inline drive mount adapter, the adapter configured with a bolt-on, wheel-hub housing and not configured with a built-in, cast or forged wheel-hub housing.

FIG. 8D is end-views of a drive beam of a drive tower structure illustrating placement of an inline wheel-drive gearmotor assembly with transfer case, the gearmotor assembly configured with a top separated parallel section of inline wheel-drive gearmotor assembly with motor controller and a bottom separated parallel section of inline wheel-drive gearmotor assembly, the top and bottom separated parallel sections linked by a transfer case. The gearmotor assembly is mounted to a drive beam of a drive tower structure of an irrigation system using a universal inline drive mount adapter with wheel-hub housing, an example embodiment. The wheel hub housing shown as casted or forged with the universal inline drive mount adapter. The illustrations provide perspective views of the top separated parallel section of inline wheel-drive gearmotor assembly with motor controller, the bottom separated parallel section of inline wheel-drive gearmotor assembly, and the transfer case, all making up the inline wheel-drive gearmotor assembly with transfer case and with a drive wheel assembly.

FIG. 8E—is a perspective end-view of a drive beam that includes an attached integrated serial section of inline wheel-drive gearbox assembly with motor controller, the assembly including a universal inline drive mount adapter with wheel-hub housing of an example embodiment, the adapter being a casting or forging that includes the built-in, wheel-hub housing. Illustrated is an in-line mounting of a complete integrated serial section of inline wheel-drive gearmotor assembly and motor controller configured to operate without a transfer case.

FIG. 8F is a perspective view of an end of a drive beam with an inline wheel-drive gearmotor assembly with transfer case mounted to the end of the drive beam, the gearmotor assembly including top and bottom separated parallel sections and a connecting transfer case, and the assembly attached at a distal end of a corresponding a universal inline drive mount adapter with wheel-hub housing of an example embodiment. The drive mount adapter attached (bolted) at a first end to a right-angle wheel-drive gearbox mount using universal wheel-drive gearbox mounting holes and universal wheel-drive gearbox attaching bolts.

FIG. 9A is a side view of a drive beam of a drive tower structure illustrating the position of drive wheel assemblies as conventionally mounted to legacy irrigation systems.

FIG. 9B is a side view of a drive beam of a drive tower structure illustrating the left and right position of the universal inline drive mount adapters mounted at a first end to the right-angle wheel-drive gearbox mounts of a corresponding drive beam (with wheel-drive gearmotor assemblies attached to a distal end).

FIG. 10 is a side view of a pipe span and drive tower structure illustrating the left and right position of drive wheel assemblies and corresponding inline wheel-drive gearmotor assemblies with transfer case as mounted to the drive beam using the universal inline drive mount adapters with wheel-hub housing of an example embodiment and illustrating the dual motor drop cable.

FIG. 11A is a perspective end-view of an inline wheel-drive gearmotor assembly with transfer case, the assembly configured with top and bottom separated parallel sections of inline wheel-drive gearmotor assembly with motor controller, the parallel sections linked (connected) by a transfer case. The transfer case gearing illustrated with a high-gear reduction ratio selected and engaged and the low-gear reduction ratio and the neutral-gear not selected or engaged.

FIG. 11B is a perspective end-view of an inline wheel-drive gearmotor assembly with transfer case, the assembly configured with top and bottom separated parallel sections, the parallel sections linked (connected) by a transfer case. The transfer case gearing illustrated with a neutral-gear selected and the high-gear reduction ratio and the low-gear reduction ratio not selected or engaged.

FIG. 11C is a perspective end-view of an inline wheel-drive gearmotor assembly with transfer case, the assembly configured with top and bottom separated parallel sections, the parallel sections linked (connected) by a transfer case. The transfer case gearing illustrated with the low-gear reduction ratio selected and engaged and the high-gear reduction ratio and the neutral-gear not selected or engaged.

FIG. 11D is a perspective side-view of a transfer case illustrating the configuration of the motor shaft with splined motor shaft gear, the driving shaft with free-wheeling gear-large, free-wheeling gear-small and the sliding splined dog gear, and the transfer case output shaft with splined gear small and splined gear large.

FIG. 12 is a perspective view of an inline wheel-drive gearmotor assembly with transfer case without selectable gear ratio reductions, e.g., with a fixed gear reduction ratio.

FIG. 13 is a finished view of the three components configured to complete an inline wheel-drive gearmotor assembly with transfer case of an example embodiment.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Some example embodiments relate to electric self-propelled mechanized irrigation systems such as center pivot and lateral move irrigation systems, hereinafter referred to as irrigation systems. More particularly, an example embodiment pertains to new methods and apparatus for enabling the placement (mounting) of an alternative set of driveline components onto corresponding drive beams of drive tower structures of existing (legacy) irrigation systems without using legacy right-angle wheel-drive gearboxes, center drive motors with gearbox, couplers, or driveshafts and without replacement or modification of corresponding drive beams. An example embodiment, as herein disclosed, may be referred to as a universal inline drive mount adapter with wheel-hub housing. The universal adapter configured to bolt onto any right-angle wheel-drive gearbox mount of any drive beam without modification to the drive beam. Another example embodiment, which may be made feasible by adoption of an example embodiment, is herein disclosed as an inline wheel-drive gearmotor assembly with transfer case. Another example embodiment pertains to methods and apparatus for configuring the inline wheel-drive gearmotor assembly with transfer case, the configuration including a top separated parallel section of an inline wheel-drive gearmotor assembly and a bottom separated parallel section of an inline wheel-drive gearmotor assembly. The configuration having the top and bottom separated parallel sections being connected by a transfer case to, thereby, configure a complete inline wheel-drive gearmotor assembly with transfer case. For another example embodiment, as herein disclosed, the transfer case may be configured with one gear reduction ratio or with two or more selectable gear reduction ratios.

Installed conventionally to each drive beam of the drive tower structures of a typical, legacy irrigation system, hereinafter referred to as an irrigation system, may be an operable set of driveline components typically including a motor drop cable for power and control of a single, center drive motor with gearbox, and two, legacy right-angle wheel-drive gearboxes—typically one left and one right. The single, center drive motor with gearbox and the two legacy right-angle wheel-drive gearboxes may be linked (connected) in series using conventional couplers (u-joints or the like) and driveshafts, together, making up corresponding drivelines conventionally used to propel the drive wheel assemblies of corresponding drive tower structures of irrigation systems over the ground. The drive wheel assemblies connected to corresponding right-angle wheel-drive gearboxes using wheel mount hub with studs and bolts.

Some embodiments described herein include methods and apparatus of replacing the operable set of driveline components, as disclosed above, by retrofitting dual, energy-efficient, inline wheel-drive gearmotor assemblies with transfer case (with or without selectable gear reduction ratios), onto existing irrigation systems without changing or modifying the existing drive beams of corresponding drive tower structures and without requiring the use of legacy driveline components, e.g., no center drive motors with gearboxes, no couplers, no driveshafts, and no legacy right-angle wheel-drive gearboxes.

An example embodiment discloses methods and apparatus for the installation of universal inline drive mount adaptors with wheel-hub housings, onto corresponding drive beams of drive tower structures of irrigation systems. In application, the adapters of an example embodiment may facilitate methods and apparatus for configuring another example embodiment onto irrigation systems. Another example embodiment being configured as an inline wheel-drive gearmotor assembly with transfer case. Using an example embodiment, e.g., drive mount adapters with wheel-hub housings, each gearmotor assembly with transfer case of another example embodiment may be placed and mounted in the space beyond the corresponding ends of a corresponding drive beam and out of the way of any impeding drive tower structure. The method of positioning and mounting the gearmotor assemblies with transfer case of another example embodiment, may be facilitated by the installation of the universal inline drive mount adapter with wheel-hub housing of an example embodiment.

The drive mount adapters with wheel-hub housing of an example embodiment, in application, may enable the retrofitting, onto a conventional electric irrigation system, of dual, energy-efficient, inline wheel-drive gearmotor assemblies with transfer case, another example embodiment. The retrofitting applicable to both towable drive tower structures and non-towable drive tower structures (The towable drive tower structure and methods significantly disclosed by Cornelius in U.S. Pat. No. 3,817,455, incorporated herein). Example embodiments together, in application, thereby, facilitate the replacement of legacy driveline components, currently and conventionally used on the operating base of over 500,000 irrigation systems. The replacement with more efficient and reliable driveline components of some example embodiments, may result in improved reliability and enhanced functionality for any new or existing irrigation system—all without requiring modification to existing drive beams or other drive tower structure. Some example embodiments may apply equally to existing irrigation systems and to new irrigation systems yet to be manufactured.

In some example methods and apparatus, the potential for replacing currently in-use legacy driveline components, listed below, with the universal inline drive mount adapters with wheel-hub housings of an example embodiment and the inline wheel-drive gearmotor assemblies with transfer case of another example embodiment may approximate:
3,500,000 center drive motors with gearbox
7,000,000 drive shafts
14,000,000 couplers (u-joints)
7,000,000 wheel-drive right-angle gearboxes

Thus, the total market for the universal inline drive mount adapters (one example embodiment) and for the inline wheel-drive gearmotor assemblies with transfer case (another example embodiment) may be 7,000,000 units of each. The total market validating the need for some example embodiments disclosed herein.

An object of the example embodiments of the systems and methods described herein may be to disclose a universal inline drive mount adapter with wheel-hub housing that, in application, may provide a practical method for replacing existing, legacy driveline components, as disclosed above, with an in-the-field installation of an inline wheel-drive gearmotor assembly with transfer case, one to propel each drive wheel assembly on a corresponding drive beam. The universal inline wheel-drive adapters with wheel-hub housing of an example embodiment may in turn each be configured with a corresponding inline wheel-drive gearmotor assembly with transfer case of another example embodiment. By using the universal inline drive mount adapters with wheel-hub housing, each inline wheel-drive gearmotor assembly may be configured either as an integrated serial section of an inline wheel-drive gearmotor assembly with motor controller (substantially disclosed by Meis, et al, in U.S. Pat. Nos. 4,616,102 and 4,693,425, incorporated herein) or as an inline wheel-drive gearmotor assembly with transfer case to replace the legacy set of driveline components. For another example embodiment, each gearmotor assembly with transfer case may be characterized as being configured by a combination of a top separated parallel section of inline wheel-drive gearmotor assembly with motor controller, a bottom separated parallel section of an inline wheel-drive gearmotor assembly, and a transfer case, the three components, when mounted to the universal inline drive mount adapters with wheel-hub housings of an example embodiment, configured to replace a legacy set of driveline components. A set of two inline wheel-drive gearmotor assemblies (e.g., a set of integrated serial section of inline wheel-drive gearmotor assemblies or a set of inline wheel-drive gearmotor assemblies with transfer case) may be suitable to replace one center drive motor with gearbox, multiple couplers and driveshafts, and two legacy right-angle wheel-drive gearboxes at a drive tower structure of an irrigation system. The replacement of the legacy driveline components of a conventional irrigation system with two inline wheel-drive gearmotor assemblies, configured onto corresponding drive beams using the universal inline drive mount adapters with wheel-hub housings, eliminates the need for the center drive motor with gearbox, couplers, driveshafts, and the energy absorbing, right-angle wheel-drive gearboxes (e.g., worm-drives), typically configured on conventional irrigation systems to propel legacy irrigation systems over the ground.

In an example embodiment, the universal inline drive mount adapter may be configured to include a wheel-hub housing, the wheel-hub housing integrated into the single piece member making up the universal inline drive mount adapter with wheel-hub housing without requiring fasteners, e.g., the wheel-hub housing may be cast or forged with and as a part of the universal inline drive mount adapter with wheel-hub housing.

In an example embodiment, the universal inline drive mount adapter may be configured with wheel-hub housing mounting holes, the mounting holes configured to enable attaching and mounting of a separate, bolt-on-wheel-hub housing. As disclosed by an example embodiment of the universal inline drive mount adapter, the adapter may be mounted to an existing drive beam.

In an example embodiment, as disclosed above, the universal inline drive mount adapters may be configured with a pattern of universal wheel-drive gearbox mounting holes at a first end that may be used to mechanically attach the universal inline drive mount adapters onto corresponding right-angle wheel-drive gearbox mounts of existing drive beams using attaching bolts that may be the same or similar to the bolts conventionally used to attach the legacy right-angle wheel-drive gearboxes to the right-angle wheel-drive gearbox mounts of the drive beam.

The universal inline drive mount adapter with wheel-hub housing, in an example embodiment, may be similar in size and function to a drive mount adapter configured with a bolt-on, wheel-hub housing, disclosed above for a second embodiment. The universal inline drive mount adapter with wheel-hub housing may also facilitate mechanically fastening the inline gearbox housing with ring gear, of an inline wheel-drive gearbox, to the universal inline drive mount adapter with wheel-hub housing, e.g., by configuring a circular depression onto the wheel-hub housing, the impression approximating the circumference and diameter of the circular, inline gearbox housing with ring gear of the inline wheel drive gearbox. The circular depression may be configured to receive, position, and support, at a distal end of the drive mount adapter with wheel-hub housing, a circular, inline gearbox housing with ring gear. By the circular depression being configured to receive the circular gearbox housing, the circular depression may be configured to precisely position and significantly support the weight and moment of the bottom separated parallel section of an inline wheel-drive gearmotor assembly onto the wheel hub housing of the universal inline drive mount adapter with wheel-hub housing. The drive motor and motor controller of a corresponding top separated parallel section of an inline wheel-drive gearmotor assembly with motor controller may be positioned and supported by an inline motor mount that is configured to attach to the distal end of a corresponding universal inline drive mount adapter with wheel-hub housing.

For an example embodiment, the universal inline drive mount adapter may be configured with a bolt-on, wheel-hub housing at a distal end (e.g., by attaching at a distal end the bolt-on, wheel-hub housing to the drive mount adapter using wheel-hub housing mounting holes and wheel-hub housing attaching bolts). The universal inline drive mount adapter with a bolt-on, wheel-hub housing configured at a distal end may be similar in size and function to a drive mount adapter with built-in, wheel-hub housing (e.g., a wheel-hub housing cast at a distal end as part of the universal inline drive mount adapter with wheel-hub housing as disclosed above for an example embodiment). The universal inline drive mount adapter with a built-in, wheel-hub housing, may also facilitate configuring the inline wheel-drive gearbox as an attachment to the universal inline drive mount adapter, e.g., by configuring the drive mount adapter with a circular hole at a distal end approximating the circumference and diameter of the inline gearbox housing with ring gear of the inline wheel drive gearbox. The circular hole may be configured to facilitate the mechanical attachment of the inline gearbox housing with ring gear onto the bolt-on, wheel hub housing, the housing being attached to the universal inline drive mount adapter using wheel-hub housing attaching bolts.

By using an example embodiment of the universal inline drive mount adapters, the mounted position (placement) of the inline wheel-drive gearmotor assemblies may occupy the open space beyond the corresponding ends of the drive beam structure. Such open position, outbound from the corresponding ends of the drive beam, facilitates configuring the gearmotor assemblies into the vertical space from below the plane of the bottom of the drive beam to the vertical space above the plane of the top of the drive beam. Using the universal inline drive mount adapters, an example embodiment, to position the inline wheel-drive gearmotor assemblies with transfer case, another example embodiment, into this vertical space, beyond the end and from below the bottom plane to above the top plane of the drive beam, facilitates an alternative configuration for a gearmotor assembly as compared to the configuration of an integrated serial section of inline wheel-drive gearmotor assembly, as disclosed by Meis, et al in U.S. Pat. Nos. 4,616,102 and 4,693,425, incorporated herein.

In another example embodiment, an inline wheel-drive gearmotor assembly with transfer case (in-lieu-of an integrated serial section of an inline wheel-drive gearmotor assembly disclosed by Meis et al), may be characterized as including two separated parallel sections connected by the transfer case:
a top separated parallel section of an inline wheel-drive gearmotor assembly with motor controller that includes a drive motor and motor controller, and a drive motor brake, the drive motor including a motor shaft configured with the splined motor shaft gear, the gear being a top-most gear of the transfer case;
a bottom separated parallel section of an inline wheel-drive gearmotor assembly that includes an inline wheel-drive gearbox configured to be propelled by the transfer case output shaft, the gearbox in turn configured to connect to a final splined output shaft of a built-in, wheel-hub assembly, the wheel-hub assembly configured for mounting of a corresponding drive wheel assembly.
a transfer case configured with a fixed gear reduction ratio or with two or more selectable gear reduction ratios and a neutral gear, the transfer case further configured to connect the rotation of the motor shaft of the top separated parallel section to the final splined output shaft of the bottom separated parallel section of an inline wheel-drive gearmotor assembly with transfer case.

In another example embodiment, the transfer case of this three-piece configuration of an inline wheel-drive gearmotor assembly with transfer case may be configured with selectable, multi-speed gear reduction ratios. For example, the transfer case may be configured to include a selectable high-gear reduction ratio configured between the splined motor shaft gear of the motor shaft of the drive motor and motor controller of the top separated parallel section of an inline wheel-drive gearmotor assembly and the transfer case output shaft, the output shaft propelling through an inline wheel-drive gearbox that is a component of the bottom separated parallel section of an inline wheel-drive gearmotor assembly. The inline wheel-drive gearbox configured with a series of two or more gear cages, each gear cage functioning in series and configured to reduce the speed (RPM) of a final splined output shaft, the final splined output shaft configured at an opposite end of a wheel mount hub with studs and bolts, the studs and bolts configured for attaching corresponding drive wheel assemblies to propel a drive tower structure over the ground.

For the transfer case, examples of a fixed-speed gear reduction ratio or of a selectable high-gear reduction ratio may be in a range of 1:1. For the inline wheel-drive gearbox connected to and propelled by the transfer case output shaft, an example of a gear reduction ratio may be in the range of 256:1. The wheel-drive gearbox reduction ratio may result from configuring the gearbox, e.g., a planetary gearbox, with a series of four each, 5:1 gear cages configured in series (5×5×5×5=625). In combination, with the transfer case configured with a fixed-gear reduction ratio or a selectable high-gear reduction ratio of 1:1, the rotation of the final splined output shaft, configured to drive a wheel-drive assembly over the ground, may have a rotation speed reduction from the rotating motor shaft through the transfer case, through the inline wheel-drive gearbox, and to the final splined output shaft as follows:

1:1 plus 625:1=625:1 reduction(1×625)

For an example embodiment, the transfer case may be configured with a selectable low-gear reduction ratio from the motor shaft of the drive motor and motor controller of the top separated parallel section of an inline wheel-drive gearmotor assembly to the transfer case output shaft connected to an inline wheel-drive gearbox configured to propel a final splined output shaft through a wheel-hub assembly and, in turn, an opposite end of the splined output shaft configured with a wheel mount hub with studs and bolts to connect with and to propel a drive-wheel assembly over the ground. For the transfer case, an example of a selectable low-gear reduction ratio may be in a range of 10:1. The gear reduction ratio for the inline wheel-drive gearbox connected to and propelled by the transfer case output shaft may be the same as the ratio for the gear box cited above for a selectable high-gear reduction ratio, e.g., 625:1. In combination, with the transfer case configured with a low-gear reduction ratio of 10:1, the rotation of the final splined output shaft, configured to propel a wheel-drive assembly over the ground, may have a rotation speed reduction from the rotating motor shaft through the transfer case, through the inline wheel-drive gearbox, and to the final splined output shaft as follows:

10:1 plus 625:1=6,250:1 reduction,e.g.,(10×625)

Respectfully, the low-gear reduction ratio (e.g., 6,250:1) may be most suitable for slower paces of movement in an example embodiment for the application of irrigation water while maintaining a constant speed of movement of the irrigation system over the ground. Respectfully, for the transfer case, the selectable high-gear reduction ratio (e.g., 625:1) may be most suitable for faster paces of movement preferred for field scouting and for application of crop inputs other than water while maintaining a constant speed of movement of the irrigation system over the ground. In both cases, the separate, selectable, gear reduction ratios (low and high) may each be configured to maintain more optimum drive motor speeds (RPM) and motor torque outputs, regardless of whether the irrigation system is applying water at a slow pace of movement, with selection of a low-gear reduction ratio of about 6,250:1, or applying chemicals at a fast pace of movement, with selection of a high-gear reduction ratio of about 625:1. In both the low-gear ratio reduction, slow pace of movement, and high-gear ratio reduction, faster pace of movement, drive motor speeds may be maintained at a more optimum RPM as compared to fixed, single gear ratio reduction inline wheel-drive gearmotor assemblies (with or without a transfer case) that may only enable adjustments to the pace of movement by on and off cycling of drive motors (legacy drives) or by varying drive motor RPM speeds, such varied motor speeds resulting in a reduction of motor torque (more recent variable-speed drive means cited above). Having a transfer case configured with two or more separate, selectable gear reduction ratios (e.g., low, and high), enables drive motor RPM, at both slower and faster paces of movement, to be maintained in ranges that may result in more optimum levels of torque output from corresponding drive motors.

The gear reduction in the transfer case and the gear reduction in the inline wheel-drive gearbox may both be configured with free-wheeling gears that do not hold the drive wheel assemblies of corresponding tower structures in place with the drive motor powered off. In other words, an irrigation system with a drive tower structure positioned on sloping terrain may roll ahead or roll back when the corresponding drive motor is powered off. Some example embodiments provide a drive motor brake on the motor shaft, the brake engaged (on) when the power to the drive motor is discontinued and the brake unengaged (off) when the power to the drive motor is on.

Some example embodiments may meet a need to provide a simple, universal inline drive mount adapter (an example embodiment) that enables the entire base of existing irrigation systems to be retrofit with inline wheel-drive gearmotor assemblies with transfer case (another example embodiment). The transfer case of another example embodiment may be configured with a fixed gear reduction ratio or with two or more different, selectable gear reduction ratios as disclosed herein, resulting in more efficient operation, added reliability, and increased system functionality. The configuration of the inline wheel-drive gearmotor assembly with transfer case may result in a narrower footprint for the drive tower structure as the structure moves along wheel tracks as the structure passes through a field with a growing crop, thereby, mitigating crop damage from the moving irrigation system. Some example embodiments, when configured with two or more gear reduction ratios, make feasible a broader range of potential speeds of movement over the ground and facilitate a widening or expansion of the fundamental functionality of the irrigation system as compared to conventional irrigation systems.

Certain drive beams of conventional irrigation systems may be configured with more than two drive wheel assemblies each driven by a corresponding, legacy right-angle wheel-drive gearbox. Some example embodiments apply only to drive beams of conventional irrigation systems that are configured with two legacy wheel-drive right-angle gearboxes and does not apply to drive beams of conventional irrigation systems that are configured with more than two legacy wheel-drive right-angle gearboxes. Irrigation systems configured with swing-arms (corner systems) may be retrofit with both the universal inline drive mounts and corresponding inline wheel-drive gearmotor assemblies with transfer cases as disclosed herein.

Further objectives of some example embodiments may not require a change in the lateral position or in the vertical position of the drive wheel assemblies in relation to the drive beams as used in conventional irrigation systems, e.g., to install the inline wheel-drive gearmotor assemblies with transfer case, using the universal drive mount adapters of some example embodiments, so as to match the location of corresponding drive wheel assemblies into the same wheel track created with legacy drive components, now removed, and to maintain unchanged the height of corresponding the drive beams above the ground surface. It is also the objective of some example embodiments to not require either replacement of or modification to existing drive beams at corresponding drive tower structures of existing irrigation systems when installing the universal inline drive mount adapters of an example embodiment and the inline wheel-drive gearmotor assemblies with transfer case of another example embodiment.

When assembled and mounted, an inline wheel-drive gearmotor assembly may be configured as an integrated serial section of an inline wheel-drive gearmotor assembly and the configuration may not include a transfer case (see Meis et al). For the integrated serial section, the drive motor and motor controller may be mounted as part of an integrated serial section of inline wheel-drive gearmotor assembly (mounted in-line and with the motor shaft and first sun gear located inside the inline wheel-drive gearbox) and the drive motor may be attached to the distal end of the inline wheel-drive gearbox using inline motor attaching bolts. When bolted together, the universal drive mount adapter with wheel-hub housing, the inline wheel-drive gearbox, the drive motor and motor controller, and the drive motor brake (all mounted in-line) make up a complete integrated serial section of an inline wheel-drive gearmotor assembly with motor controller. The drive motor brake may be attached to the first end or the distal end of the motor shaft of the drive motor and motor controller to enable stopping of any movement of the drive tower structure when the drive motor is not powered on. The drive motor brake may be required due to the free rolling, high efficiency of the transfer case gearing and the inline wheel-drive gearboxes as disclosed herein.

With two inline wheel-drive gearmotor assemblies installed onto corresponding universal inline drive mount adapters with wheel-hub housings as disclosed above, and each gearmotor assembly positioned respectfully beyond the opposing ends of a corresponding drive beam, the overall wheelbase of the drive wheels may be extended in a range of about twenty-inches. The original height of the drive beam above the ground may be maintained unchanged. Furthermore, the gear reduction associated with inline wheel-drive gearboxes that may selectively use planetary, epicyclic, and spur gear gearing (the gearing configured into both the integrated serial section of inline wheel-drive gearmotor assembly with motor controller and the bottom separated parallel section of inline wheel-drive gearmotor assembly with transfer case) may be more efficient as compared to gearing that uses single-stage reduction, legacy right-angle wheel-drive gearboxes (with worm gears). Furthermore, selectively using multi-stage, planetary, epicyclic, cycloidal, and spur gear gearing in the inline wheel-drive gearboxes, as disclosed above, may be less prone to heat creation at higher speeds; and, thereby, may be more suitable for functions such as high-speed movement for field scouting using sensors mounted on irrigation systems and for more effective and efficient application of liquid inputs to the field. Both higher and lower speeds of movement of an irrigation system may be characterized as being facilitated by configuring a corresponding transfer case with both a selectable low-gear reduction ratio, for slower paced irrigation applications, and a selectable high-gear reduction ratio, for faster paced scouting and application of crop inputs such as chemicals.

The selection among any plurality of gear reduction ratios configured into the transfer case may be performed either manually by local operators or remotely by signals to electronic, hydraulic, or pneumatic actuators that may control movement of a shift changing fork and mechanism. Such dynamic changes to the pace of movement of an irrigation system using selectable gear reduction ratios, as disclosed for another example embodiment, may be optimally achieved using remote signals sent to electronic, hydraulic, or pneumatic actuators configured to select gear reduction ratios or a neutral gear (e.g., shift gears by movement of the shift changing fork) within a transfer case of an inline wheel-drive gearmotor assembly with transfer case, such remote signals may be characterized as an example means of controlling the movement of the shift changing fork, rather than making such gear reduction ratio changes manually in the field.

For transfer cases with selectable gear reduction ratios, some embodiments may include a “neutral” gear that prevents the motor shaft from driving (rotating) a transfer case output shaft and vice-versa. Such neutral gearing would facilitate towing of the drive tower structures, even with the motor brake engaged to stop the motor shaft movement. This feature of a neutral gear may be selectively used when drive wheel assemblies of the plurality of drive tower structures may each be configured at a right angle, to the normal direction of movement, to facilitate the towing of an irrigation system (the towable drive tower structure and methods significantly disclosed by Cornelius in U.S. Pat. No. 3,817,455, incorporated herein). This right-angle configuration of drive wheel assemblies may be suitable for conventional towing of an irrigation system from either the center pivot tower or from an end-most drive tower structure.

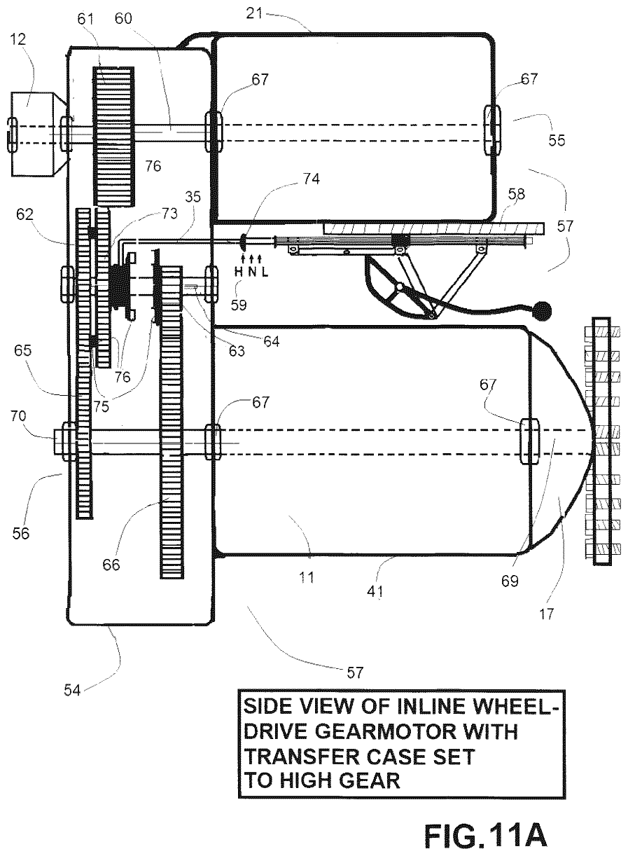

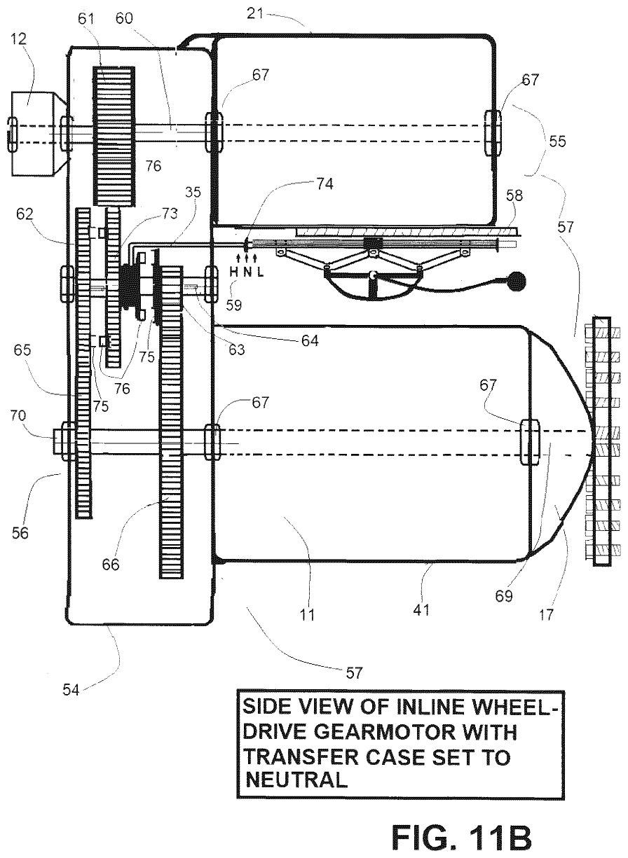

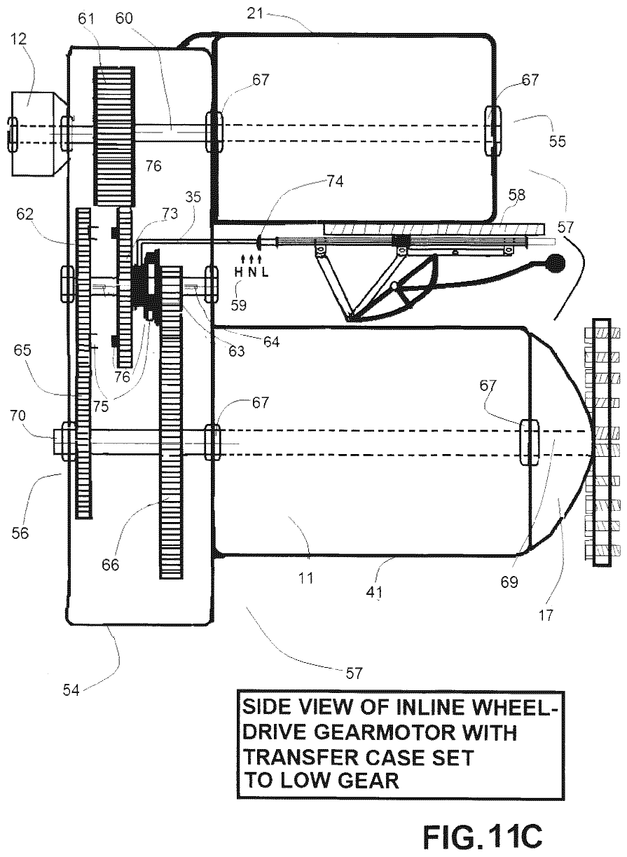

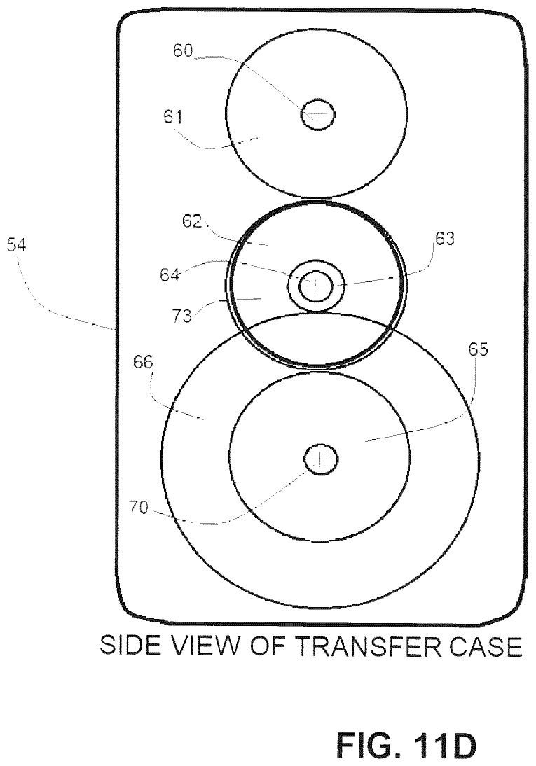

With the selectable neutral gearing in a transfer case as disclosed in FIG. 11B, a drive tower structure could be towed with the transfer case gearing set to neutral and with the power supply discontinued, e.g., with the motor brake engaged. This results because the motor brake has no effect on the rotation (freewheeling) of a final splined output shaft that may rotate with movement of the drive wheel assemblies, while the transfer case is in neutral, and the drive wheel assemblies are configured for towing.

Another feature of the neutral setting of a transfer case may be to use the outer-most drive tower structure configured with an inline wheel-drive gearmotor assembly to move an irrigation system configured for towing. For example, all intermediate drive tower structures may be set to neutral (with motor brakes engaged) and the intermediate drive tower structures configured for towing. The outermost drive tower structure, with drive wheels configured for towing, may, for example, be set to low-gear and the drive motor and controller of the corresponding outer most inline wheel-drive gearmotor assemblies with transfer case provided power from a portable power supply such as a generator. The portable supply power may provide power to the drive motors and motor controllers of a last drive tower structure, and, thereby, enable the outermost inline wheel-drive gearmotor assemblies to pull the plurality of intermediate drive tower structures of an irrigation system in the intended direction for towing.

Each drive motor and motor controller, rather mounted as an integrated serial section without a transfer case or as top and bottom separated parallel sections connected by a transfer case, may be configured with a motor controller, e.g., a variable-speed drive controller such as a VFD, to provide variable speeds of movement, including higher speeds suitable for application of crop inputs through the water delivery pipe spans or through separate, chemical only, delivery lines as disclosed in U.S. Patent Application No. 63/119,994 and U.S. Patent Application No. 63/120,004, both filed Dec. 1, 2020. The higher speeds of movement may also facilitate the practical use of sensors mounted to the structure of the pipe spans to enable more rapid field scouting for collection of sight-specific data points useful in creating prescriptions for treating site-specific crop stresses and for site-specific application of water and nutrients.

Such configurations of dual, inline wheel-drive gearmotor assemblies with transfer case, as disclosed above, are not limited to this disclosure. Other alternative means of providing selectable gear reduction ratios may be suitable for irrigation systems and may include methods disclosed by Jae-Oh Han, Jae-Won Shin, Jae-Chang Kim and Se-Hoon Oh in an article published in Applied Science, September 2019 titled: “Design 2-Speed Transmission for Compact Electric Vehicle Using Dual Brake System”, the article incorporated herein.

Either with the built-in, wheel-hub housing cast as part of the universal inline drive mount adapter or with the bolt-on, wheel-hub housing configured as a separate component from the universal inline drive mount adapter (second embodiment), the universal inline drive mount adapters may be both intended to facilitate the installation, on any existing electric irrigation system, of an inline wheel-drive gearmotor assembly for each drive wheel assembly. Furthermore, the gearmotor assembly may either be configured with an integrated serial section of inline wheel-drive gearmotor assembly with motor controller, as substantially disclosed by Meis, et al, or the gearmotor assembly may be configured, as disclosed herein, with top and bottom separated parallel sections, e.g., an inline wheel-drive gearmotor assembly with transfer case. Installation of the drive mount adapters with wheel-hub housing and inline wheel-drive gearmotor assemblies, as disclosed herein, may improve irrigation system efficiency and reliability while increasing the overall functionality of the irrigation systems.

The dual, inline wheel-drive gearmotor assemblies, as disclosed herein, may be mounted to any existing drive beam of a drive tower structure using the following steps:
decoupling the existing center drive motor with gearbox, e.g., disconnecting the driveshafts and couplers thereof,
unwiring the legacy motor drop cable from the electrical source of power and control to the center drive motor with gearbox,
removing the existing legacy, right-angle wheel-drive gearboxes from each corresponding right-angle wheel-drive gearbox mount of a corresponding drive beam,
installing two universal inline drive mount adapters of some embodiments may include, one onto each corresponding right-angle wheel-drive gearbox mount of a corresponding drive beam,
Installing inline wheel-drive gearmotor assemblies (the assemblies configured either as an integrated serial section without transfer case or as separated parallel sections with transfer case), one left and one right, onto the corresponding universal inline drive mount adapters, and
Installing a dual motor drop cable connecting electrical control and power circuits discretely to each corresponding drive motor and motor controller of corresponding inline wheel-drive gearmotor assemblies now mounted to the corresponding drive beam.

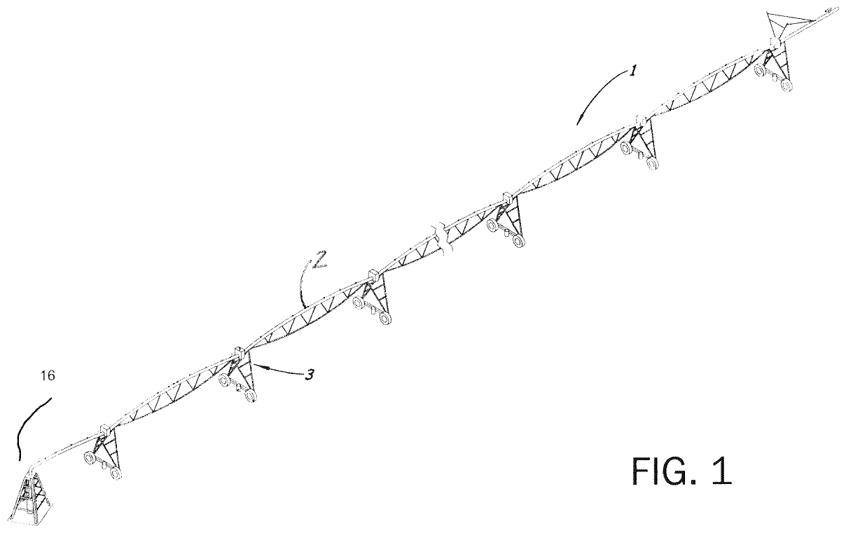

On installation, the universal inline drive mount adapters with wheel-hub housing, an example embodiment, may be configured to extend the length of the wheelbase of the drive wheels outboard, beyond the corresponding ends of the drive beam, to enable space for the inline wheel-drive gearmotor assemblies to be mounted horizontally and vertically at corresponding positions beyond the respective ends of the existing drive beams. Providing such extended space, extending outboard, beyond the corresponding ends of the drive beam, may prevent the drive tower structure from impeding with the space required for the functional placement of the inline wheel-drive gearmotors with transfer case. Configuring the inline wheel-drive gearmotor assemblies with transfer case to be mounted outboard, beyond the corresponding ends of the drive beam, may provide needed space for the mounting of the gearmotor assemblies that otherwise would require significant modification to the drive beams as disclosed in FIGS. 1, 2 and 3 of the cited U.S. Pat. No. 4,618,102, by Meis, et al. For some embodiments, such extended mounting positions for the inline wheel-drive gearmotor assemblies with transfer case enables the inline wheel-drive gearmotor assemblies to each be compacted and mounted to not require a change or modification to the drive beams of conventional irrigation systems.

The inline wheel-drive gearmotor assemblies disclosed herein may have a series of a plurality of more efficient inline gear reducers (rather than a single-stage reduction) that may result in a higher percentage energy conversion in a range of 80-90 percent. Such higher ranges of efficiencies may be typical of planetary gearboxes, epicyclic gearboxes, cycloidal gearboxes, or spur gear gearboxes as disclosed herein or planetary gearboxes, epicyclic gearboxes, cycloidal gearboxes, or spur gear gearboxes as disclosed by Meis, et al, in U.S. Pat. Nos. 4,616,102 and 4,693,425, incorporated herein. Furthermore, the higher horsepower requirements to overcome the inherent inefficiency of the legacy, single-stage, worm-drive gearboxes also add to the stress and wear on components of the drivelines connecting the higher horsepower motors to the legacy right-angle wheel-drive gearboxes that provide the needed output shaft speed reduction. The present disclosure includes methods of eliminating center drive motors with gearboxes, couplers, driveshafts, and legacy right-angle wheel-drive gearboxes, with their energy absorbing right-angle gear sets, and replacing such legacy driveline components with inline wheel-drive gearmotor assemblies with transfer cases as disclosed herein to thereby improve the efficiency of operation and the reliability of drive components while expanding the overall functionality of any legacy irrigation system. As disclosed herein, functionality may include the feature of two or more selectable gear reduction ratios for the transfer case of inline wheel-drive gearmotor assemblies with transfer case as disclosed herein.

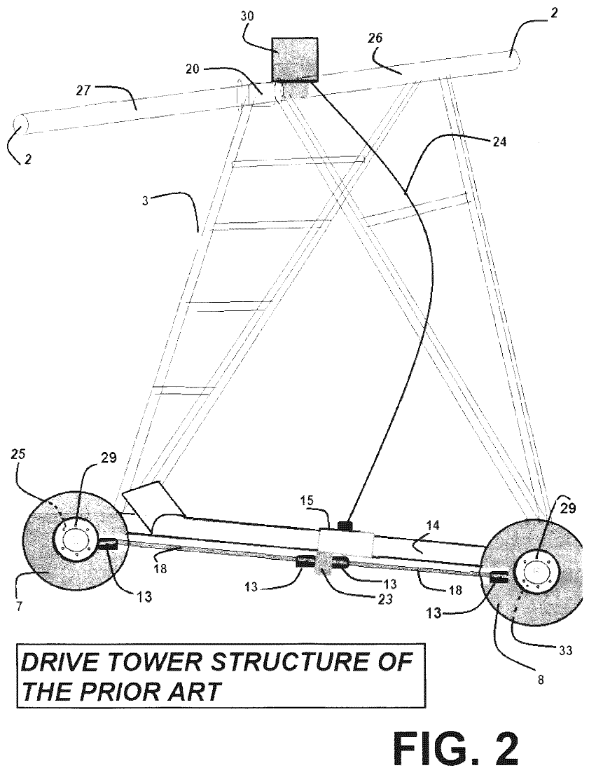

Referring to FIG. 1, the irrigation system 1 with a plurality of pipe spans 2, each pipe span 2, supported by a drive tower structure 3 as the span pipe distal end 26, shown in FIG. 2, rotates about a center pivot tower 16, shown in FIG. 1. Such an irrigation system 1 is traditionally termed a center pivot irrigation system, herein referred to as an irrigation system 1.

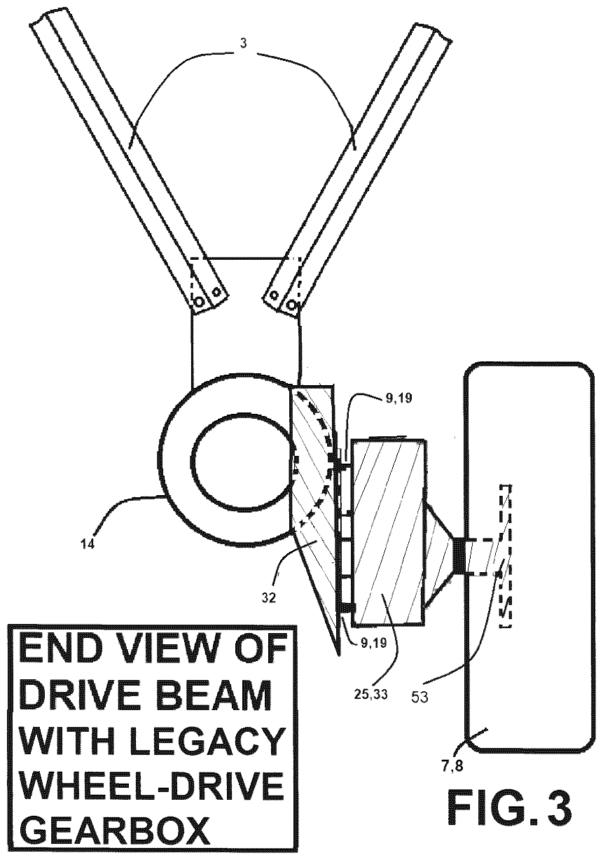

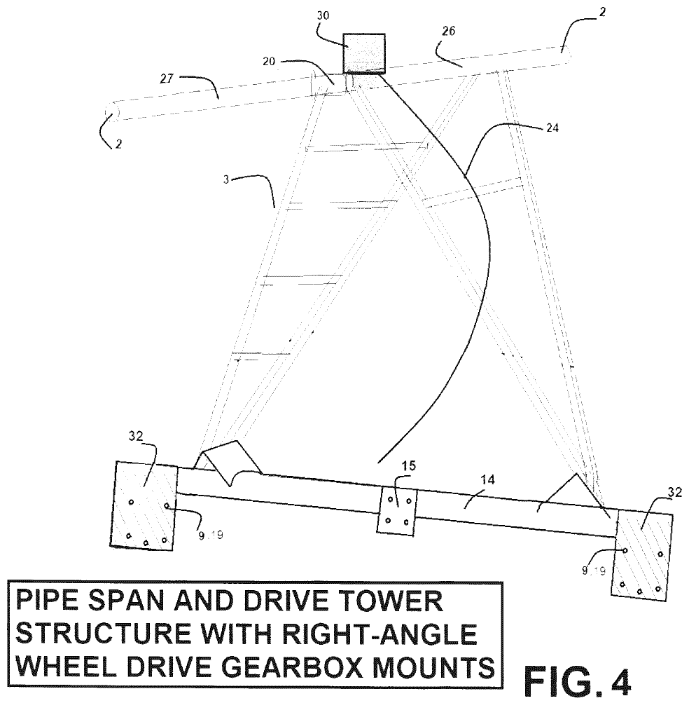

Referring to FIG. 2, each drive tower structure 3 supports a corresponding pipe span 2 using a span pipe distal end 26 that incorporates a flex joint 20 that provides fluid connection between a span pipe distal end 26 and a span pipe first end 27 of an adjacent pipe span 2. The drive tower structure 3 includes a drive beam 14 with one or more drive wheel assemblies 7,8, the wheel assemblies 7,8 connected to (mounted to) a corresponding legacy right-angle wheel-drive gearbox 25,33 (one left and one right), the wheel-drive gearboxes 25,33 may each be attached to drive beam 14, using corresponding right-angle wheel-drive gearbox mounts 32, shown in FIG. 4, and universal wheel-drive gearbox attaching bolts 19 through universal wheel-drive gearbox mounting holes 9, all shown in FIGS. 3 and 4. The legacy right-angle wheel-drive gearboxes 25,33 may be connected to corresponding drive wheel assemblies 7,8 using wheel mount hubs with studs and bolts 53, FIG. 3, that may include wheel lug bolts 29, FIG. 2, for propelling corresponding drive tower structures 3 over the ground surface. Referring to FIG. 2 the legacy right-angle wheel-drive gearboxes 25,33 are driven through corresponding input shafts (not shown) of each legacy right-angle wheel-drive gearbox 25,33. The input shafts driven by a corresponding rotating driveshaft 18, connecting with couplers 13, to the legacy center drive motor with gearbox 23. The legacy center drive motor with gearbox 23 is conventionally mounted to drive beam 14 using legacy motor mount 15 and connected to a power source from a tower control box 30 using a legacy motor drop cable 24, FIG. 2.

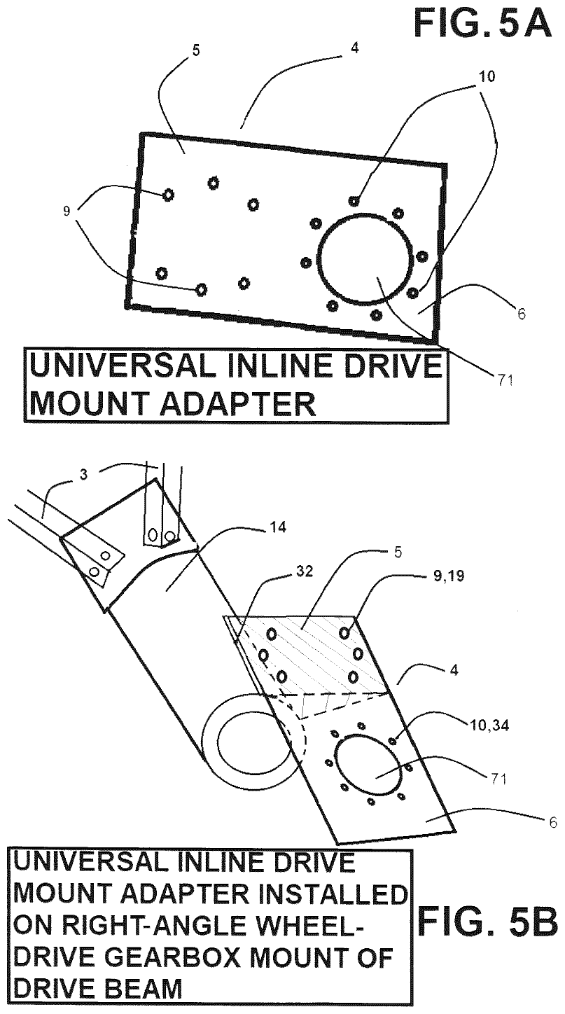

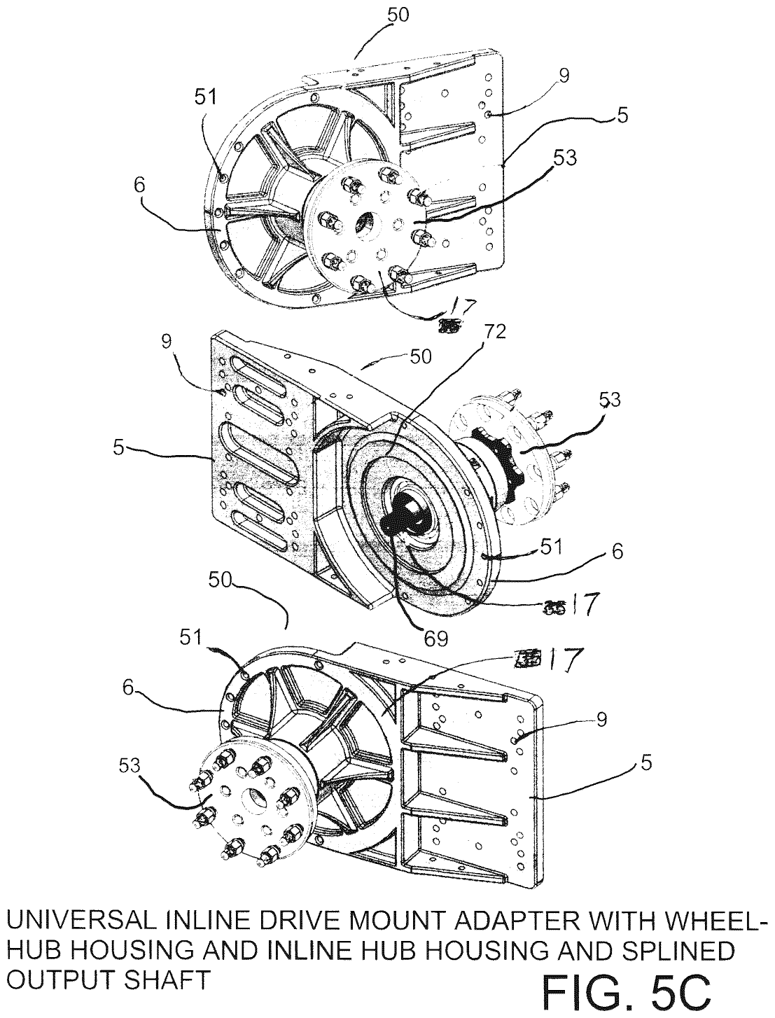

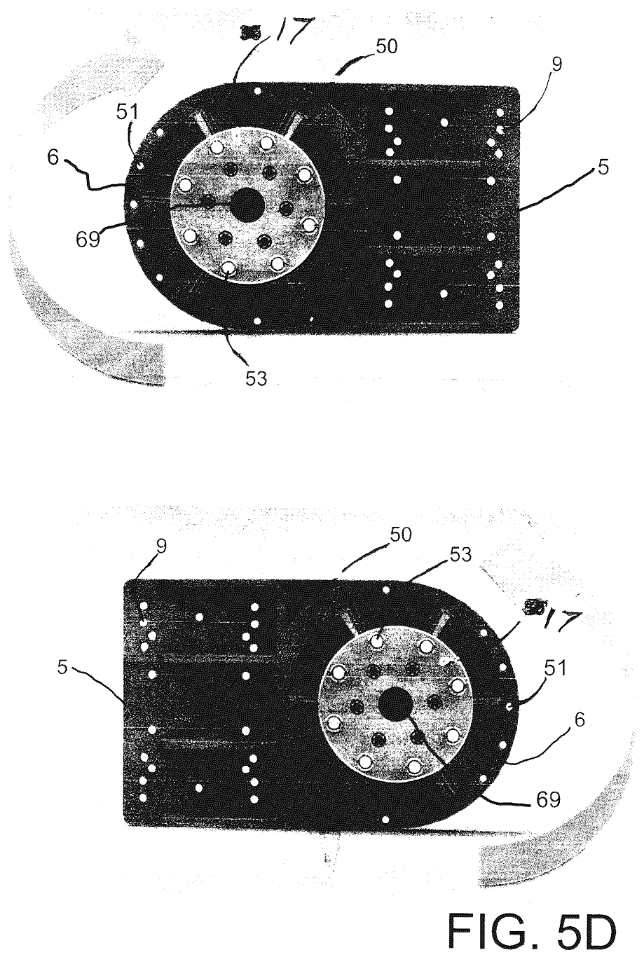

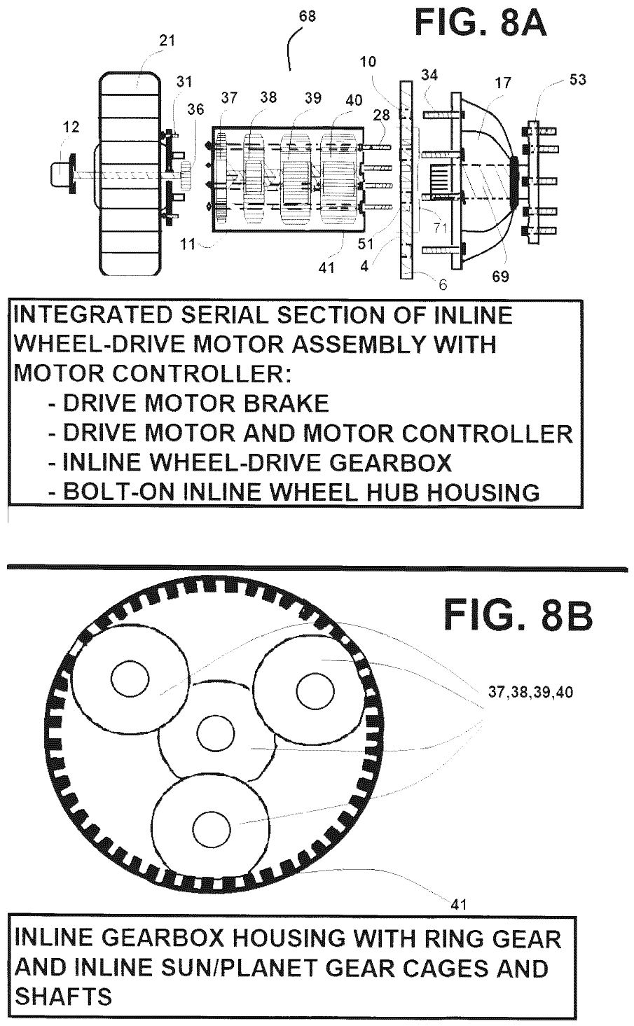

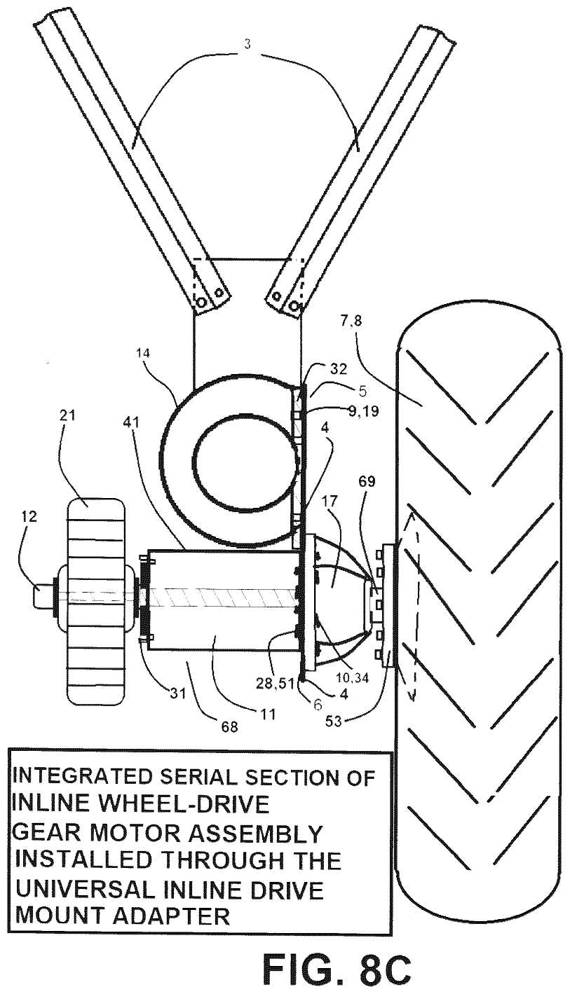

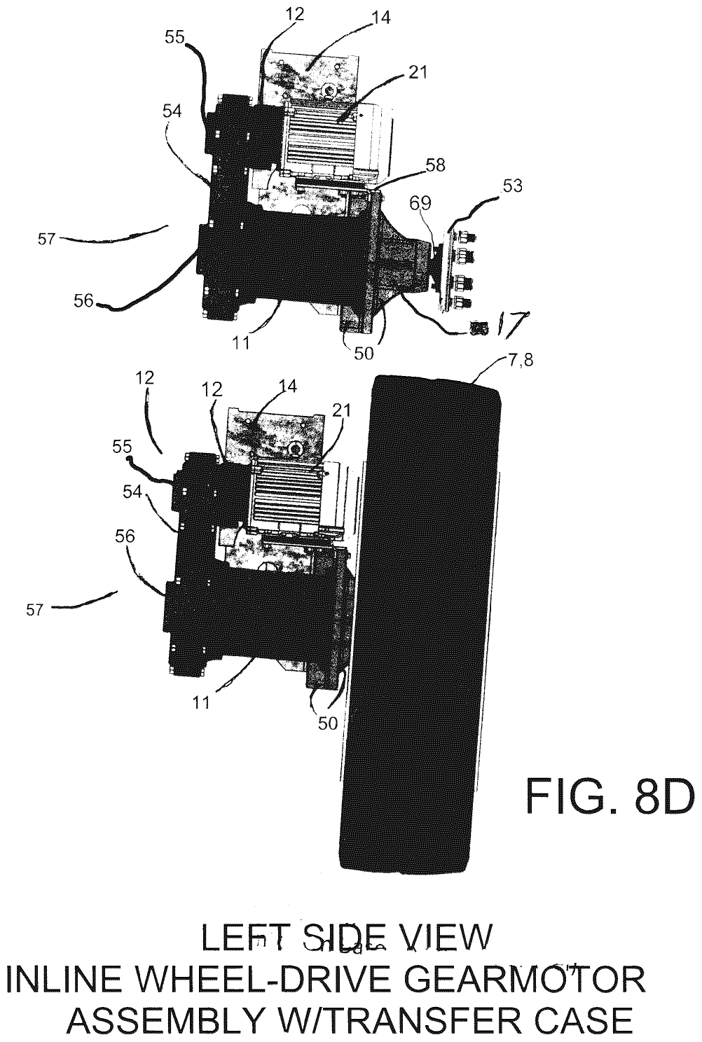

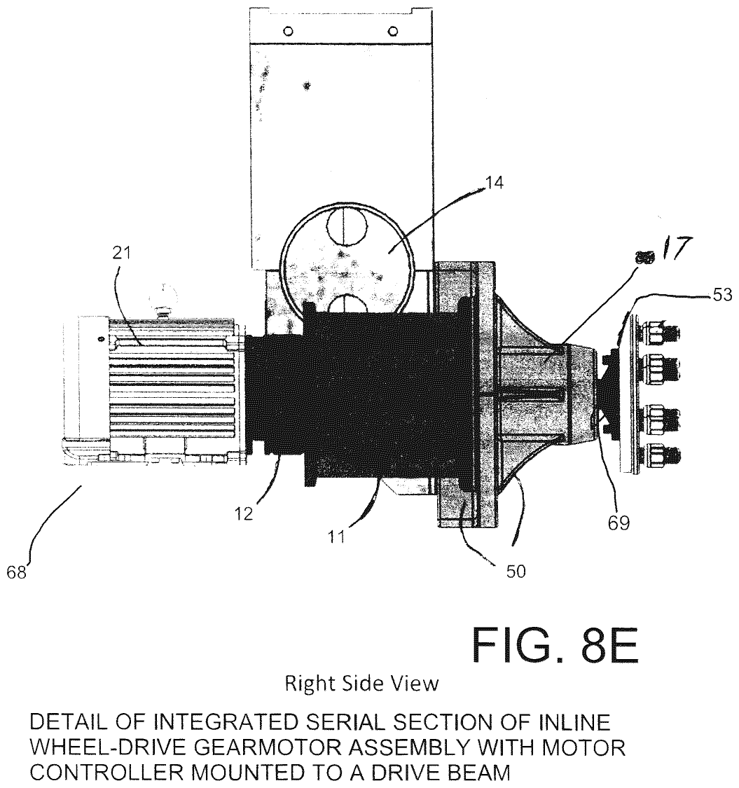

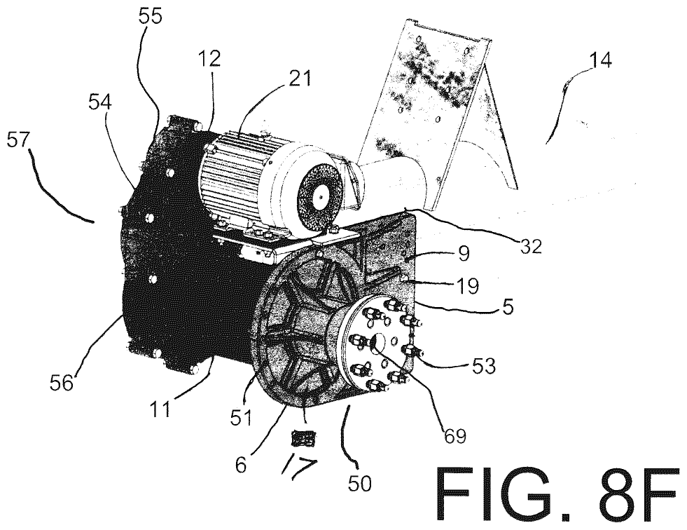

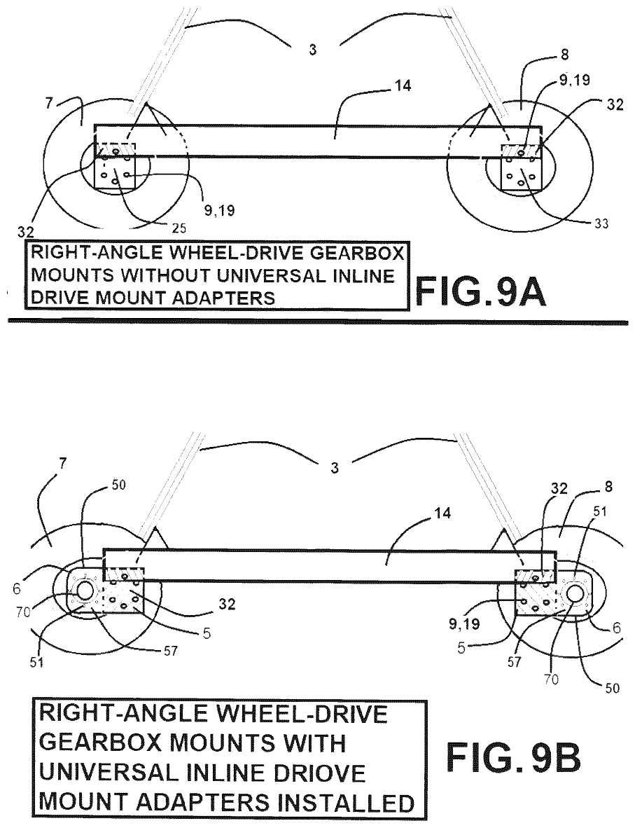

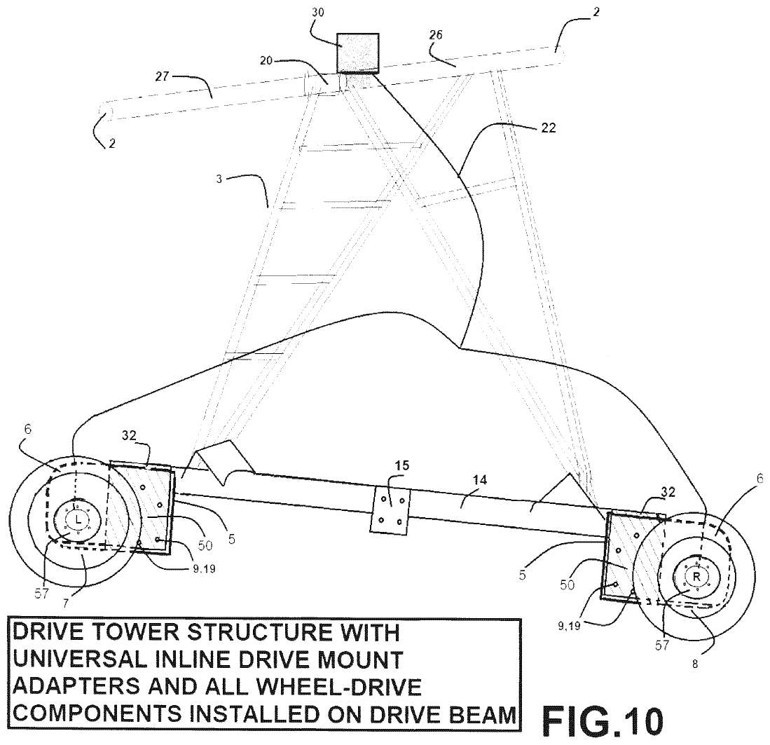

For an irrigation system 1, an example embodiment may include a universal inline drive mount adapter with wheel-hub housing 50 shown in FIGS. 5C, 5D, and 9B. At distal end 6 of the adapter 50 is a built-in wheel-hub housing 17, a wheel mount hub with studs and bolts 53, a final splined output shaft 69, a circular depression 72 for supporting and aligning the inline gearbox housing with ring gear 41 (shown in FIGS. 8A, 8B, and 9B), and inline gearbox attaching holes 51. At first end 5 of the adapter 50 are universal wheel-drive gearbox mounting holes 9. The adapter 50 being configured to facilitate an in-the-field exchange at a drive tower structure 3 of a legacy center drive motor with gearbox 23, and the legacy right-angle wheel-drive gearboxes 25,33, the legacy components shown mounted to a drive beam 14 in FIG. 2 and the legacy components shown removed from the drive beam 14 in FIG. 4.

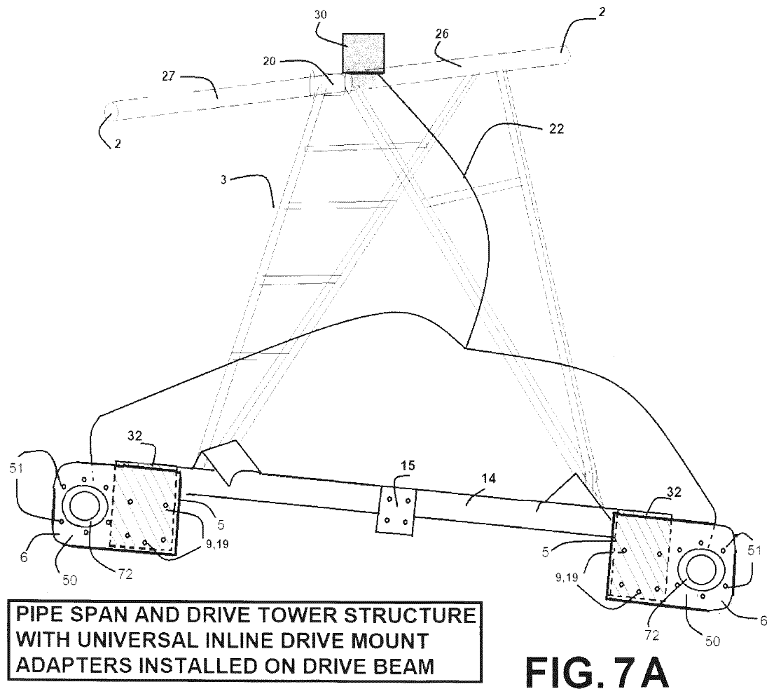

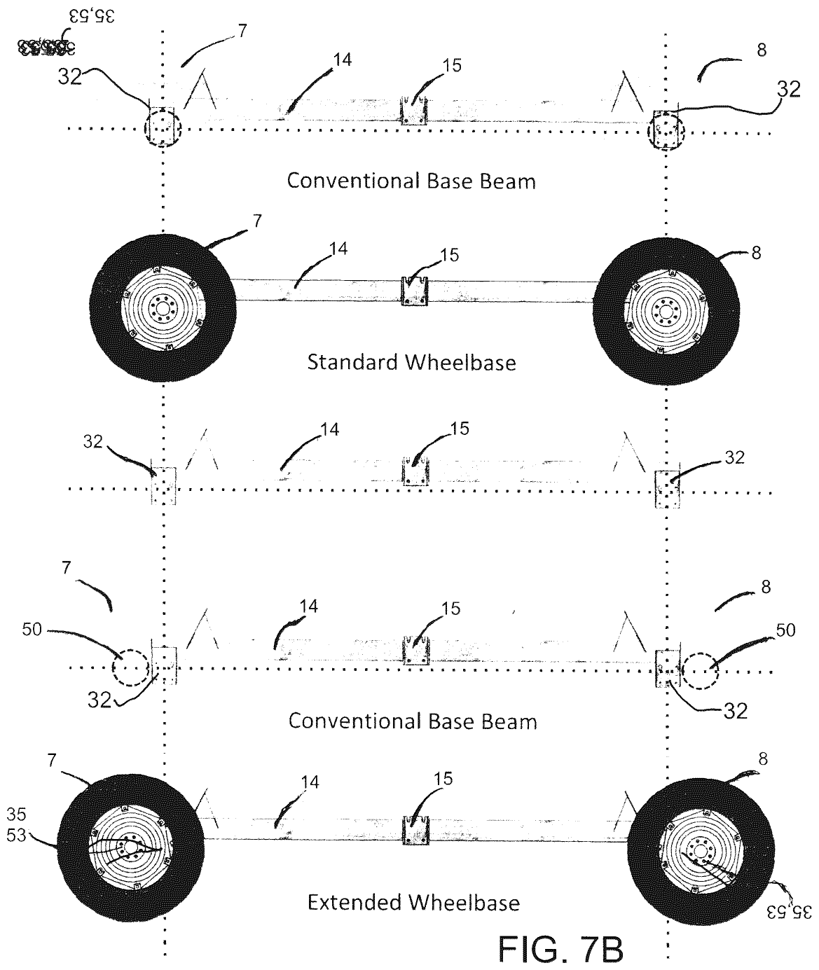

In FIG. 8F, an inline wheel-drive gearmotor assembly with transfer case 57 is shown mounted to a distal end 6 of a universal inline drive mount adapter with wheel-hub housing 50. The adapter 50 in turn may be mounted at a first end 5 to a right-angle wheel-drive gearbox mount 32 of drive beam 14. The first end 5 of adapter 50 being configured to align with and attach to the gearbox mount 32, the adapter 50 at a first end 5 characterized as being configured with a plurality of corresponding, matching, universal wheel-drive gearbox mounting holes 9 and being attached to gearbox mount 32 using a corresponding plurality of universal wheel-drive gearbox attaching bolts 19. Note, for an example embodiment, the in-the-field exchange of each legacy right-angle wheel-drive gearbox 25,33 for a corresponding inline wheel-drive gearmotor assembly with transfer case 57 may be configured using a universal inline drive mount adapter with wheel-hub housing 50 as shown in FIGS. 8F and 9B. With reference to FIG. 8D, the in-the-field exchange may not change or modify the drive beam 14 and not changing or modifying the lateral position of the drive wheel assemblies 7,8 onto the ground in relationship to a wheel track that may be established by the wheel assemblies 7,8 when conventionally attached to legacy right-angle wheel-drive gearboxes 25,33 of conventional irrigation systems, as shown in FIG. 7B. Also, with reference to FIGS. 7B, 9A, and 9B, the in-the-field exchange of legacy right-angle wheel-drive gearboxes 25,33 for the inline wheel-drive gearmotor with transfer case 57 may be further include not changing the height of the drive beam 14 above the ground surface as compared to the height of corresponding drive beams 14 when using conventional irrigation systems.

For an example embodiment, the reconfiguration of any existing irrigation system 1 to the use of an inline wheel-drive gearmotor assembly with transfer case 57, as shown in FIGS. 8D and 8F, may start with the drive beam 14, as shown in FIG. 4, wherein the legacy, center drive motor with gearbox 23 and the two (left and right) legacy right-angle wheel-drive gearboxes 25,33 have been removed. Alternatively, and not shown, the center drive motor with gearbox 23 may remain mounted to the drive beam 14 and simply be decoupled from the drive shafts 18 and couplers 13, as shown in FIG. 2.

Referring to FIGS. 5A and 5B, another example embodiment discloses the use of a universal inline drive mount adapter 4, having two sets of hole patterns: (1) universal wheel-drive gearbox mounting holes 9 at a first end 5 and (2) a circular hole 71 and a circular pattern of inline wheel-hub housing mounting holes 10 at a distal end 6. Referring to FIG. 5B the universal inline drive mount adapter 4 is shown mounted (attached) at a first end 5 to the legacy right-angle wheel-drive gearbox mount 32 of drive beam 14 of tower structure 3 using the universal wheel-drive gearbox mounting holes 9 and universal wheel-drive gearbox attaching bolts 19, the adapter 4 including a matching pattern of mounting holes 9 at a first end 5, the corresponding holes 9 also provided in the right-angle wheel-drive gearbox mount 32 of a drive beam 14. As shown in FIGS. 5A and 5B, the universal inline drive adapter 4, at a distal end 6, may include a circular hole 71 and inline wheel-hub housing mounting holes 10 for receiving, positioning, and attaching a bolt-on, wheel-hub housing 17, using inline wheel-hub housing attaching bolts 34 illustrated in FIG. 8A. The circular hole 71 may also serve as a guide to attaching and supporting an inline gearbox housing with ring gear 41 as shown in FIG. 8A.

In contrast to the above disclosure of another example embodiment configured with a universal inline drive mount adapter 4, as shown in FIGS. 5A and 5B, with a bolt-on, wheel-hub housing 17, shown in FIG. 8A, an example embodiment may use a universal inline drive mount adapter with wheel-hub housing 50, the adapter 50 including a built-in, wheel-hub housing 17 with a circular depression 72 shown in FIG. 5C at a distal end 6 (in-lieu-of a bolt-on, wheel-hub housing 17, as shown in FIG. 8A).

FIGS. 5C and 5D are perspective views of a universal inline drive mount adapter with wheel-hub housing 50, an example embodiment, illustrating at a first end 5 universal wheel-drive gearbox mounting holes 9 for attaching the drive mount adapter with wheel-hub housing 50 to the right-angle wheel-drive gearbox mount (not shown) and illustrating at a distal end 6 the built-in, wheel-hub housing 17, e.g., a wheel hub housing 17 cast or forged with the universal inline drive mount adapter 50, the wheel-hub housing 17, as shown in FIG. 5C, configured with a circular depression 72 and corresponding inline gearbox attaching holes 51 for receiving, positioning, and attaching a circular inline gearbox housing with ring gear 41 of an inline wheel-drive gearbox 11 to the universal inline drive mount adapter with wheel-hub housing 50. Also illustrated is a wheel mount hub with studs and bolts 53 supported by the wheel-hub housing 17.

With reference to FIG. 5D, the universal inline drive mount adapter 50 of an example embodiment being configured with matching universal wheel-drive gearbox mounting holes 9 at a first end 5. The mounting holes 9 being configured in a hole pattern that matches the hole pattern 9 used with both the left and right legacy right-angle wheel-drive gearbox mounts 32. By simply rotating the adapter 50 by 180 degrees, as shown in FIG. 5D, the adapter 50 being configured at a first end 5 to mount to either the right or the left right-angle wheel-drive gearbox mounts 32 of a drive beam 14 without modification.

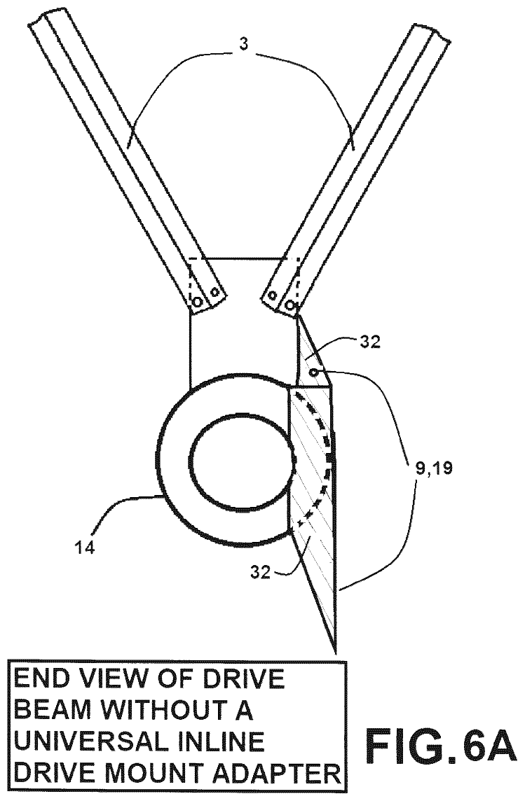

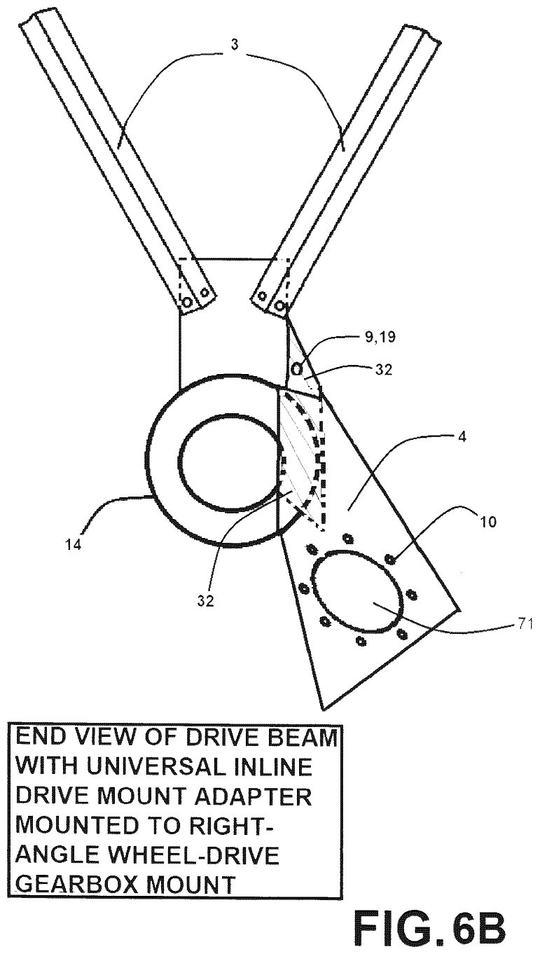

FIG. 6A illustrates the position of a legacy right-angle wheel-drive gearbox mount 32, including the universal wheel-drive gearbox mounting holes 9. The gearbox mount 32 is shown conventionally attached (typically by welding) onto a corresponding outer end of a drive beam 14 of a drive tower stricture 3.

FIG. 6B is a second perspective view of a universal drive mount adapter 4 attached at a first end 5 to a right-angle gearbox mount 32 of a drive beam 14 using universal wheel-drive gearbox mounting holes 9 and universal wheel-drive gearbox attaching bolts 19. The adapter 4 also configured at a distal end with a circular hole 71 and inline wheel-hub housing mounting holes 10.

FIG. 7A illustrates a drive tower structure 3 with a pair (left and right) of universal drive mount adapters with wheel-hub housing 50 positioned and attached (bolted) at a first end 5 onto the legacy right-angle wheel-drive gearbox mounts 32 of a drive beam 14 using the corresponding, matching, universal wheel-drive gearbox mounting holes 9, the holes 9 and matching holes 9 configured respectfully in both the adapter 50 at a first end and in the gearbox mount 32, the attachment configured by the use of the universal wheel-drive gearbox attaching bolts 19. The adapters 50 at a distal end 6 include a circular depression 72 suitable for positioning and supporting an inline gearbox housing with ring gear 41 (shown in FIG. 8A). The universal drive mount adapters with wheel-hub housing 50, as attached, may extend the approximate 144-inch-long legacy wheelbase (not shown) of drive beam 14 beyond the corresponding ends of drive beam 14 by about 20-inches—compare the horizontal mounting positions of the two corresponding drive wheel assemblies 7,8 as shown in FIG. 9A and in FIG. 9B. The result may be a wheelbase for drive beam 14 as shown in FIG. 10 that may be extended, e.g., by 20-inches, to be approximately 164 inches long. Such longer wheelbase may be advantageous in preventing pipe spans 2 of irrigation systems 1 from being blown over in windstorms.

FIG. 7B Illustrates perspective views of drive beams 14 and corresponding wheelbase lengths of conventional irrigation systems for comparison to wheelbase lengths resulting from configuring the drive beams 14 with universal inline drive mount adapters with wheel-hub housings 50, the configuration of drive mount adapters 50 being an example embodiment.

It is recognized that other embodiments will be apparent to those of skill in the art after a review of the disclosure of the instant application. It is further recognized that additional other embodiments will be apparent to those of skill in the art after a review of the disclosure of the instant application and the materials incorporated by reference into the instant application. Such alternative embodiments may use a universal inline drive mount adapter with wheel-hub housing 50 and may include configuring an inline wheel-drive gearmotor assembly 57,68 using universal inline wheel-drive adapter 4, a second embodiment, as illustrated in FIGS. 5A, 5B, and 6B. In-lieu-of-using the adapter 50, the adapter 4 may be configured with a bolt-on, wheel-hub housing 17 as illustrated in FIG. 8A. For either configuration, in application a drive mount adapter 4,50 may be suitable for some embodiments.

An example embodiment incorporates aspects of the integrated serial section of an inline wheel-drive gearmotor assembly with motor controller 68 substantially disclosed in U.S. Pat. No. 4,618,102, Meis, et al. The Meis patent discloses the use of a planetary inline wheel-drive gearbox on an irrigation system 1; the Meis patent requires a custom drive beam 14 design, the design retaining the legacy use of a conventional center drive motor with gearbox 23 (FIG. 2 of the instant application and FIG. 1 of the Meis patent). In contrast, some embodiments may include the use of a universal inline drive mount adapter 4,50, the use not requiring modification to the design of any existing drive beam 14 as configured with any drive tower structure 3 of conventional irrigation systems 1 (illustrated in various perspective views in FIGS. 4, 5B, 6B, 8F, 9B, and 10). The universal inline drive mount adapter 4, 50 facilitating the reconfiguration and upgrading of any existing electric irrigation system 1 to the use of inline wheel-drive gearmotor assemblies 57, 68. The inline wheel-drive gearmotor assembly with transfer case 57 illustrated in FIGS. 8D, and 8F and integrated serial section of an inline wheel-drive gearmotor assembly with motor controller 68 illustrated in FIGS. 8A, 8C, and 8E.

FIG. 8A is an exploded side view of an integrated serial section of inline wheel-drive gearmotor assembly with motor controller 68, showing a drive motor brake 12, a drive motor and motor controller 21, an inline wheel drive gearbox 11, and a bolt-on, wheel-hub housing 17. FIG. 8A also shows the position of a universal inline drive mount adapter 4 as the inline wheel-hub housing mounting holes 10, at a distal end 6 of adapter 4, align with the inline wheel-hub housing attaching bolts 34 of the bolt-on, wheel-hub housing 17. For an embodiment, FIG. 8A also illustrates the attachment of the circular, inline gearbox housing with ring gear 41 of an inline wheel-drive gearbox 11 to the bolt-on, wheel-hub housing 17, through a circular hole 71 using inline gearbox attaching bolts 28 through inline wheel-hub housing mounting holes 10. FIG. 8A also illustrates the splined output shaft 69 of the wheel-hub housing 17 that is propelled by the inline fourth (or final) sun/planet gear cage with shafts 40 of the gearbox 11. The drive motor and motor controller 21 is attached to the inline wheel-drive gearbox 11 using inline motor attaching bolts 31 and the drive motor 21 includes an inline motor shaft and first sun gear 36 that mates to the inline first sun/planet gear cage with shafts 37. For an example embodiment, the wheel-hub housing 17 may alternatively be cast or forged with the drive mount adapter 4, thereby, resulting in the universal inline drive adapter with wheel-hub housing 50 (FIG. 5C), an example embodiment.

The inline wheel-drive gearbox 11 as illustrated in FIG. 8A includes four sets of gear cages with shafts 37,38,39,40. The number and ratio of sets of gear cages 37,38,39,40 may be any number of one or more. Each of the gear cage 37,38,39,40, mounted in series, provide an incremental reduction in speed (RPM) of inline motor shaft and first sun gear 36. In an example each gear cage 37,38,39,40 may provide a 5:1 gear reduction ratio and a cumulative gear reduction ratio as follows:

| | | Cumulative |
|---|---|---|
| (1) | Ratio | Ratio |
| Inline first sun/planet gear cage with shafts 37 | 5:1 | 5:1, |
| Inline second sun/planet gear cage with shafts 38 | 5:1 | 25:1, |
| Inline third sun/planet gear cage with shafts 39 | 5:1 | 125:1, |
| Inline fourth sun/planet gear cage with shafts 40 | 5:1 | 625:1. |

FIG. 8B is an end view of the inline gearbox housing with (internal) ring gear 41. FIG. 8B also illustrates the location of components of the inline sun/planet gear cages 37, 38, 39, 40 inside the inline wheel-drive gearbox 11 as they may stack horizontally and serially into the opening of the inline gearbox housing with ring gear 41.

FIG. 8C illustrates the approximate location of the integrated serial section of inline wheel-drive gearmotor assembly with motor controller 68 when attached to a distal end 6 of a universal drive mount adapter 4, configured with a bolt-on, wheel-hub housing 17. The adapter 4 mounted at a first end 5 to a right-angle wheel-drive gearbox mount 32 of a drive beam 14. Referring to FIG. 8A, the inline gearbox housing with ring gear 41 of the integrated serial section of inline wheel-drive gearmotor assembly 68 is attached to the bolt-on, wheel-hub housing 17 through the circular hole 71 (FIGS. 5A and 5B) using inline gearbox attaching bolts 28. Note that the bolt-on, wheel-hub housing 17 being attached to the outside and opposite side of the distal end 6 of the adapter 4 using inline wheel-hub housing attaching bolts 34 as shown in FIG. 8A. The first end 5 of the universal inline drive mount adapter 4 being attached to a corresponding right-angle wheel-drive gearbox mount 32 using universal wheel-drive gearbox mounting holes 9 and universal wheel-drive gearbox attaching bolts 19 (FIGS. 8C, and 9B).

FIG. 9A illustrates the comparative location of the left and the right drive wheel assemblies 7,8 when mounted to a corresponding legacy right-angle wheel-drive gearbox 25,32 that may be mounted directly to a corresponding right-angle wheel-drive gearbox mount 32. FIG. 9B illustrates the comparative location of the left and the right drive wheel assemblies 7,8 when mounted to a wheel-hub housing 17 at a distal end 6 of a universal inline drive mount adapter with wheel-hub housing 50 of some embodiments. The position of the drive wheel assemblies 7,8 being about ten inches outboard of the corresponding ends of drive beam 14 when mounted to the distal end 6 of the adapter 50. As illustrated, the center line of the drive wheel assemblies 7,8 as illustrated in FIG. 9B are positioned outboard from the corresponding ends of the drive beam 14 as compared to the position illustrated in FIG. 9A for conventional irrigation systems. This outboard positioning for some embodiments may provide space for locating either the integrated serial section of inline wheel-drive gearmotor assembly with motor controller 68 (FIGS. 8C and 8E) or the more compact, inline wheel-drive gearmotor assembly with transfer case 57 (FIGS. 8D and 8F) outboard and away from the corresponding ends of drive beam 14 and at a height off the ground that may be the same or similar to the height of the drive beam 14 as shown in FIG. 9A. The extension of the wheelbase by the use of the universal inline drive mount adapters 4,50, may also result in improved wind-load capacity of winds otherwise capable of rolling over pipe spans 2 of irrigation systems 1.

FIG. 10 illustrates a frontal view of a drive tower structure 3 configured with inline wheel-drive gearmotor assemblies with transfer case 57 (another example embodiment) mounted at a distal end 6 of a corresponding adapter 50. A first end 5 of the adapter 50 is attached (mounted) to a right-angle wheel-drive gearbox mount 32 using universal wheel-drive gearbox mounting holes 9 and universal wheel-drive gearbox attaching bolts 19. Such configuration, including a conversion of a legacy drive tower structure 3 with drive beam 14 of irrigation system 1 to a configuration including the use of the example embodiments. The conversion when applied to any or all drive tower structures 3 of an irrigation system 1 may result in improved efficiency and expanded functionality. With reference to FIGS. 8D and 8F, note that the inline wheel-drive gearmotor assembly with transfer case 57 includes a drive motor and motor controller 21 and drive motor brake 12 that may be attached directly to the transfer case 54 and in turn the transfer case output shaft 70 (not shown) being configured to drive the inline wheel-drive gearbox 11 without requirement for couplers 13, legacy driveshafts 18, and the right angle worm gear reducers of the legacy wheel drive gearbox 25,33 of conventional irrigation systems (see FIG. 2). FIG. 10 also illustrates the use of a dual motor drop cable 22 to provide discrete control and power to each drive motor and controller 21 of the inline wheel-drive gearbox assemblies with transfer case 57, e.g., a left and a right drive motor and controller 21.

FIGS. 11A, 11B, and 11C are each a perspective illustration of an inline wheel-drive gearmotor assembly with transfer case 57. For the following disclosures all three illustrations, e.g., A, B, and C should be referenced. The transfer case 54 of the gearmotor assembly being configured with two or more, selectable gear reduction ratios and with a neutral gear, the gear reduction ratios configured to be selected inside transfer case 54, including selection of a neutral gear, by movement of a shift changing fork and mechanism 35. The fork and mechanism 35 may be characterized as being configured to control the movement of the sliding splined dog gear 73, the dog gear 73 splined onto a section of driving shaft 64 and engaged full-time with splined motor shaft gear 61. The dog gear 73 may be characterized as being positioned between a free-wheeling gear-large 62 on a first side (e.g., a high gear reduction ratio selection, reference FIG. 11A), and free-wheeling gear-small on a second side (e.g., a low gear reduction ratio selection, reference FIG. 11C), the free-wheeling gears 62,63 not splined to driving shaft 64. The sliding splined dog gear 73 may be characterized as being configured on a first side and on a second side with multiple dog teeth 76, the dog teeth 76 being equally spaced in a circular pattern on each side of the dog gear 73, each of the circular patterns of dog teeth 76 protruding perpendicular and outward from a corresponding side of the dog gear 73. In turn, the free-wheeling gears 62,63 may each be configured with a corresponding circular pattern of dog teeth windows 75, each of the corresponding circular patterns of dog teeth windows 75 being configured to lock-in, engage with, and receive (mate with) corresponding dog teeth 76 from a corresponding side of the sliding splined dog gear 73. Note that the dog teeth 76 of sliding splined dog gear 73 may be characterized as being sized and shaped to lock-in to and engage with corresponding dog teeth windows 75 of the free-wheeling gears 62,63. With sliding splined dog gear 73 configured to slide laterally on a splined section (not shown) of driving shaft 64, the sliding action of dog gear 73 may be initiated by the movement of shift changing fork 35. In turn, with the sliding (movement) of dog gear 73 along a splined section of driving shaft 64 the dog teeth 76 on each corresponding side of dog gear 73 may be characterized as being configured to lock-in and engage with the corresponding pattern of dog teeth windows 75 of free-wheeling gears 62,63. Each free-wheeling dog gear 62,63, when locked-in and engaged with the dog teeth 76 of sliding splined dog gear 73, may be characterized as providing a discrete gear reduction ratio of either a high gear reduction ratio (FIG. 11A) or a low gear reduction ratio (FIG. 11C).

With reference to FIG. 11A, the high gear reduction ratio may result from free-wheeling gear-large 62 (when locked-in and engaged with dog gear 73, the gear 73 driven by splined motor shaft gear 61) driving the transfer case output shaft 70 by propelling splined gear small 65. With reference to FIG. 11C, the low gear reduction ratio may result from free-wheeling gear-small 63 (when locked-in and engaged with dog gear 73 driven by splined motor shaft gear 61) driving the transfer case output shaft 70 by propelling splined gear large 66. Alternatively, with reference to FIG. 11B, a neutral gear may be selected by the movement of dog gear 73 wherein neither pattern of dog teeth 76 of dog gear 73 may be engaged or locked-in with corresponding dog teeth windows 75 of the free-wheeling gears 62,63.

The selection of a high-gear reduction, a low-gear reduction, or a neutral gear may be characterized as being accomplished by the movement of the shift changing fork and mechanism 35 to align the shift changing fork indicator 74 with a corresponding character (marker) on gear selection indicator 59, e.g., align the shift changing fork indicator 74 with the character “H” of the gear selection indicator 59 when a high gear reduction ratio may be required, as shown in FIG. 11A; or align the shift changing fork indicator 74 with the character “L” of the gear selection indicator 59 when a low gear reduction ratio may be required, as shown in FIG. 11C. Similarly, the selection of the neutral gear may be characterized as being accomplished by the movement of the shift changing fork and mechanism 35 to align the shift changing fork indicator 74 with the character “N” of the gear selection indicator 59 when a neutral gear may be required, as shown in FIG. 11B.

With reference to FIGS. 11A, 11B, and 11C, the movement of shift changing fork 35 may be characterized as being controlled manually by an operator in the field or as being controlled remotely by a signal to a pneumatic, hydraulic, or electric actuator (not shown).

The sliding splined dog gear 73 may be internally splined (not shown) and slid onto an externally splined section (not shown) of driving shaft 64 and the dog gear 73 may always be engaged (meshed) with the splined motor shaft gear 61; and dog gear 73 may be propelled by the rotation of motor shaft 60, e.g., the sliding splined dog gear 73 may always be rotating when the motor shaft 60 is rotating. As shown in FIG. 11A, the sliding splined dog gear 73 only drives (rotates) an adjacent free-wheeling gear-large 62 when the dog teeth 76 of the sliding splined dog gear 73 may be meshed and locked-in (by the movement of shift changing fork and mechanism 35) with the corresponding dog teeth window 75 of the free-wheeling gear-large 62. In turn, as shown in FIG. 11C, the sliding splined dog gear 73 only drives (rotates) an adjacent free-wheeling gear-small 63 when the dog teeth 76 of the sliding splined dog gear 73 may be meshed and locked-in (by the movement of shift changing fork 35) with the corresponding dog teeth window 75 of the free-wheeling gear-small 63.

Referring to FIG. 11A, the transfer case 54 of an inline wheel-drive gearmotor assembly with transfer case 57, in an example, may be characterized as being configured to operate with a high-gear reduction ratio, e.g., in a range of 1:1 to 5:1, depending on a specific configuration of gear teeth. Regardless of the number of teeth configured into a splined motor shaft gear 61, splined motor shaft gear 61 has an adequate width to maintain a connection to (engage with) the sliding splined dog gear 73 regardless of the lateral position of the sliding splined dog gear 73, the position determined by movement of the shift changing fork and mechanism 35, either manually by an operator or remotely by a signal. Selection of the high-gear reduction ratio of 1:1 may include the lateral positioning of the shift changing fork 35 to align a shift changing fork indicator 74 with a gear selection indicator 59 including the marker “H”, the marker “H” stamped or otherwise visible on an external surface of the transfer Case 54. The lateral positioning of the sliding splined dog gear 73 when the shift changing fork indicator 74 is aligned with the any one character, e.g., “H”, “N”, or “L”, of the gear selection indicator 59, results in the following configurations of gears within transfer case 54:
For selection of a high gear reduction ratio and with reference to FIG. 11A, a splined motor shaft gear 61 may be continuously engaged (meshed) with the sliding splined dog gear 73, the dog gear 73 positioned by the movement of the shift changing fork and mechanism 35 to align shift changing fork indicator 74 with a high gear selection (“H”) on the gear selection indicator 59 and the positioning including the corresponding pattern of dog teeth 76 of the dog gear 73 and the pattern of dog teeth windows 75 of free-wheeling gear-large 62, the dog teeth 76 and dog teeth window 75 being configured to be locked-in. The configuration, in an example, resulting in a gear reduction ratio of 1:1 through transfer case 54 as the free-wheeling gear-large (now locked to the sliding splined dog gear 73) drives the splined gear small 65 that in turn rotates the transfer case output shaft 70 in the 1:1 ratio.
For selection of a low gear reduction ratio and with reference to FIG. 11C, a splined motor shaft gear 61 may be continuously engaged (meshed) with the sliding splined dog gear 73, the dog gear 73 positioned by the movement of the shift changing fork and mechanism 35 to align shift changing fork indicator 74 with a low gear selection (“L”) on the gear selection indicator 59 and the positioning including the corresponding dog teeth 76, of both the dog gear 73 and the free-wheeling gear-small 63, being configured to be locked-in. In an example, the configuration resulting in a gear reduction ratio of 10:1 through transfer case 54 as the free-wheeling gear-small 63 (now locked to the sliding splined dog gear 73) drives the splined gear large 66 that in turn rotates the transfer case output shaft 70 in the 10:1 ratio.

For selection of a neutral gear and with reference to FIG. 11B, a splined motor shaft gear 61 may be continuously engaged (meshed) with the sliding splined dog gear 73, the dog gear 73 positioned by the movement of the shift changing fork and mechanism 35 to align shift changing fork indicator 74 with a neutral gear selection (“N”) on the gear selection indicator 59 and the positioning including the corresponding dog teeth 76 of the sliding splined dog gear 73 not being engaged with either of the free-wheeling gear-large 62 or free-wheeling gear-small 63, e.g., not being configured to be locked-in. The configuration resulting in no rotation of either the free-wheeling gear-large 62 or the free-wheeling gear-small 63 and thereby no rotation of transfer case output shaft 70.

With reference to FIGS. 11A, 11B, and 11C, it should be noted that motor shaft 60, driving shaft 64, transfer case output shaft 70 and final splined output shaft 69 may each be positioned and supported by two or more bearings and seals 67.

Referring to FIG. 11A, in a high gear example, the transfer case output shaft 70 may be configured to drive the inline sun/planet gear cages with shafts 37,38,39,40 of inline wheel-drive gearbox 11 (illustrated in FIG. 8A). In the example, the inline wheel-drive gearbox 11 may be configured with a gear reduction ratio in the range of 625:1, 5×5×5×5 through the in-line sun/planet gear cages 37,38,39,40, as shown in FIG. 8A. In the high gear example and with reference to FIG. 11A, the gear reduction ratio among the splined motor shaft gear 61, the sliding splined dog gear 73, the free-wheeling gear-large 62, and the splined gear small 65 in the transfer case 54 may be serially configured to result in a 1:1 gear reduction ratio when the sliding splined dog gear 73 is set to the high gear reduction ratio. For this example, the final splined output shaft 69 of wheel-hub housing 17 has a reduction equal to the gear reduction configured into wheel-drive gearbox 11 of 625:1 multiplied by the gear reduction ratio of transfer case 54 of 1:1, e.g., 625×1=625:1.

Referring to FIG. 11C, in a low gear reduction ratio example, the transfer case output shaft 70 may be configured to drive the inline sun/planet gear cages with shafts 37,38,39,40 of inline wheel-drive gearbox 11 (illustrated in FIG. 8A). In the example, the inline wheel-drive gearbox 11 may again be characterized as being configured with a gear reduction ratio in the range of 625:1, 5×5×5×5 through the in-line sun/planet gear cages 37,38,39,40, as shown in FIG. 8A. In the low gear example and with reference to FIG. 11C, the gear reduction ratio among the splined motor shaft gear 61, the sliding splined dog gear 73, the free-wheeling gear-small 63, and the splined gear large 66 in the transfer case 54 may be serially configured to result in a 10:1 gear reduction ratio when the dog teeth 76 of sliding splined dog gear 73 may be locked-in and engaged with the dog teeth windows 75 of free-wheeling gear-large 62 to thereby result in a low gear reduction ratio. For this low gear example, the final splined output shaft 69 of wheel-hub housing 17 has a reduction, from the splined motor shaft gear 61 to the splined gear large 66, equal to the gear reduction configured into wheel-drive gearbox 11 of 625:1 multiplied by the gear reduction ratio of transfer case 54 of 10:1, e.g., 625×10=6,250:1.

Referring to FIG. 11B, in a neutral gear example, the transfer case output shaft 70 may be configured to drive the inline sun/planet gear cages with shafts 37,38,39,40 of inline wheel-drive gearbox 11. In the example, the inline wheel-drive gearbox 11 may configured with a gear reduction ratio in the range of 625:1, 5×5×5×5 through the in-line sun/planet gear cages 37,38,39,40, as shown in FIG. 8A. In the neutral gear example and with reference to FIG. 11B, the gear reduction ratio among the splined motor shaft gear 61 and the sliding splined dog gear 73 may be 1:1. However, in the neutral gear selection the dog teeth 76 of dog gear 73 and the dog teeth windows 75 of corresponding free-wheeling gear-large 62 and the free-wheeling gear-small 63 may not be engaged or locked-in. The result of the neutral gear selection may be neither the free-wheeling gear-large 62 or the free-wheeling gear-small 63 being rotated by the sliding splined dog gear 73. In turn, neither the splined gear small 65 nor the splined gear large 66 in the transfer case 54 are being driven by a corresponding free-wheeling gear-small 63 or a free-wheeling gear-large 62, the gears 65,66 splined to transfer case output shaft 70. Finally, for this neutral gear example, the final splined output shaft 69 of wheel-hub housing 17 may be characterized as being configured to rotate the transfer case output shaft 70 (e.g., by rotation of drive wheel assemblies 7,8), with the transfer case output shaft 70 spinning (rotating) the free-wheeling gears 62,63 while the gears 62,63 are not locked-in or engaged with sliding splined dog gear 73. Therefore, with the neutral gear selected, the final splined output shaft 69 may be free-wheeling with no engaged gear connection completed back to the splined motor shaft gear 61, even with motor shaft 60 inoperable and locked, with the supply power discontinued and the drive motor brake 12 engaged.

Although a range of drive wheel assemblies 7,8 may include any of several common tire sizes, a typical drive wheel assembly 7,8 may include an 11.2×38 inch tire size. Such a tire may have a circumference of about 14.4 feet. A drive motor and motor controller 21 may be controlled to output variable rates of RPM and such variable rates of RPM may typically include a 3,000 RPM by the motor 21. In an example and referring to the selection of the high-gear ratio illustrated in FIG. 11A, with a 625:1 gear reduction between the RPM of a motor shaft 60 of drive motor and controller 21 and a final splined output shaft 69 of an inline wheel-drive gearmotor assembly with transfer case 57, the drive wheel assembly 7,8 may have a rotation speed of (3,000 RPM/625 reduction)=4.8 RPM. With a circumference of 14.4 feet on an 11.2×38 inch tire of a drive wheel assembly 7,8, the resulting distance per minute over the ground of a corresponding drive tower structure 3 may be (4.87 RPM×14.4 feet)=70.1 feet per minute. Referring to FIG. 1, an irrigation system 1 may typically have a linear length from a center pivot tower 16 to the wheel track (not shown) of an outermost drive tower structure 3 approximating 1,260 feet. Such a configuration for an irrigation system 1 may result in the circumference of a wheel track (not shown) at an outermost drive tower structure 3 of (2×3.1416×1,260)=7,916 feet. Referring to the pace over the ground of an outermost drive tower structure 3 of 70.1 feet per minute disclosed for the above example, the time to complete a single rotation (pass) of an irrigation system 1 may approximate: (7,916 feet/70.1 feet per minute=112.9 minutes or 1.9 hours. Such a pace of movement over the ground of 70.1 feet per minute may result from an operator of an irrigation system 1 moving the shift changing fork and mechanism 35 of a transfer case 54 to align shift changing fork indicator 74 with marker “H” of the gear selection indicator 59, as illustrated in FIG. 11A. Such pace of movement of 70.15 feet per minute may be most suitable for timely application of crop inputs to a field or for scouting the field using cameras, sensors and the like mounted to the structure of an irrigation system 1 as disclosed herein. Such a pace of movement of 70.1 feet per minute, may include selection of a high-gear reduction ratio in a transfer case 54, may not provide a suitable pace of movement for application of irrigation water. If the high-gear reduction ratio may be selected for a single irrigation pass, the resulting amount of irrigation water applied to a field may be calculated to be in a range of (112.9 minutes×800 gallons per minute/120 acres/27,154 gallons per acre inch)=0.027 acre inches. With the exception of cooling a stressed crop, such a light application of irrigation may not be useful to a growing crop. However, such a speed of movement of 70 feet per minute, provided by the selection of a high-gear in a transfer case 54, may be optimum for applying crop inputs, through irrigation system 1, such as pesticides, herbicides, crop nutrients, and the like, herein disclosed by U.S. Provisional Patent Application No. 63/119,994 and U.S. Provisional Patent Application No. 63/120,004, both filed Dec. 1, 2020.

Adoption of variable speed drive motors and controllers for the above examples, as herein disclosed as conventional irrigation systems, may enable even faster paces of movement for a drive tower structure 3 configured to operate with selection of a high-gear reduction ratio. The high-gear selection may be configured for (positioning) the shift changing fork indicator 74 of shift changing fork and mechanism 35 to align with the marker “H” of gear selection indicator 59 (FIG. 11A). For example, by using a variable-speed drive motor and controller 21, the RPM of the drive motor 21 may be sped up from the 3,000 RPM, used in the above examples, to 3,600 RPM. The 3,600 RPM may result in a faster RPM: (3,600 RPM/625 reduction)=5.76 RPM at a drive wheel assembly 7,8. This may result in a faster pace of movement at an outermost drive tower structure 3. In the example assuming drive wheel assemblies 7,8 with a circumference of 14.4 feet may result in a pace of movement over the ground of 83 feet per minute ((14.4×5.76)=83.0 feet per minute). Using the above example, for the irrigation system 1 with a wheel track circumference of 7,916 feet, the faster pace of 83 feet per minute would result in a single irrigation pass of (7,916 feet/83 feet per minute)=95 minutes or 1.59 hours. Staying with the 800 gallons per minute pumping rate, used in the above example, such an irrigation pass would result in the following acre inches of application of water to the entire field: (800 GPM×95 minutes)/120 acres/27,154 gallons per acre inch=0.02 acre inches.

Referring to FIG. 8A and FIG. 11C, selection of a low-gear reduction ratio may be configured (positioning) the shift changing fork indicator 74 of shift changing fork and mechanism 35 to align with the marker “L” of gear selection indicator 59. In an example, the selection of a low-gear reduction ratio in transfer case 54 by positioning the shift changing fork indicator 74 of shift changing fork and mechanism 35 to align with the marker “L” of gear selection indicator 59 may result in a free-wheeling gear-small 63 being locked-in and engaged with the sliding splined gear 73 and thereby driving a splined gear large 66. This configuration of a free-wheeling gear-small 63 propelling (rotating) the splined gear large 66 significantly reduces the relative speed (RPM) of the transfer output shaft 70 being driven by splined gear large 66 as compared to a high-gear selection disclosed in FIG. 11A, wherein splined gear small 65 may be driving transfer output shaft 70. In an example, for the low-gear selection, there may be a gear reduction ratio for the transfer case 54 in a range of 10:1 between the splined motor shaft gear 61 and the transfer case output shaft 70, the low-gear reduction ratio dependent on specific gear ratios among a splined motor shaft gear 61, a sliding splined dog gear 73, a free-wheeling gear-small 63 and a splined gear large 66. The transfer case output shaft 70 in turn drives the gear cages with shafts 37,38,39,40 of inline wheel-drive gearbox 11. In the example and as disclosed above, the gearbox 11 may be configured with a gear reduction ratio in a range of 625:1. Continuing with the example, for the selection of a low-gear reduction ratio for the transfer case 54 as illustrated in FIG. 11C, the final splined output shaft 69 may therefore have a total gear ratio reduction, from the rotation of motor shaft 60 and splined motor shaft gear 61 in transfer case 54 to the rotation of the final splined output shaft 69 of a wheel hub housing 17 of a universal inline drive mount adapter with wheel-hub housing 50, in a range of 6,250:1. The total reduction of 6,250:1, may include the selection of a low-gear reduction ratio of 10:1 in the transfer case 54 and a corresponding 625:1 reduction in the wheel-drive gearbox 11, may be calculated as follows: (10×625)=6,250. As in the above example for the high-gear reduction illustrated in FIG. 11A, the reduction of 625:1 through wheel-drive gearbox 11 may result from gear reduction ratios of 5:1 for each of four respective sun/planet gear cages with shafts 37,38,39,40 (shown in FIG. 8A). In the example, such configuration of the four gear cages with shafts 37,38,39,40 resulting in the 625:1 gear reduction ratio (5×5×5×5=625) for selection of a high hear reduction ratio.

As noted above, a typical drive wheel assembly 7,8 may include an 11.2×38 inch tire size with a circumference of about 14.4 feet. A drive motor and motor controller 21 may be configured to output variable rates of RPM and such variable rates of RPM may typically include an 1,800 RPM by the motor 21. In an example and referring to the low-gear reduction ratio illustrated in FIG. 11C, with a 6,250:1 gear reduction between the RPM of a motor shaft 60 of drive motor and motor controller 21 and a final splined output shaft 69 of an inline wheel-drive gearmotor assembly with transfer case 57, the drive wheel assembly 7,8 may have a rotation speed of (1,800 RPM/6,250 reduction)=0.29 RPM. With a circumference of 14.4 feet on an 11.2×38 inch tire of a drive wheel assembly 7,8, the resulting distance per minute over the ground of a corresponding drive tower structure 3 may be (0.29 RPM×14.4 feet)=4.18 feet per minute. Referring to FIG. 1, an irrigation system 1 may typically have a linear length from a center pivot tower 16 to the wheel track (not shown) of an outermost drive tower structure 3 approximating 1,260 feet. Such a configuration for an irrigation system 1 may result in the circumference of a wheel track at an outermost drive tower structure 3 of (2×3.1416×1,260)=7,916 feet. Referring to the pace over the ground of an outermost drive tower structure 3, with the transfer case 54 configured to operate in the low-gear reduction ratio, of 4.18 feet per minute disclosed herein, the time to complete a single rotation (pass) of an irrigation system 1 may approximate: (7,916 feet/4.18 feet per minute=1,8949 minutes or 31.6 hours. Such a pace of movement over the ground of 4.18 feet per minute may result from an operator of an irrigation system 1 moving the shift changing fork and mechanism 35 of a transfer case 54 to align shift changing fork indicator 74 with marker “L” of gear selection indicator 59, as illustrated in FIG. 11C. Such a pace of movement of 4.18 feet per minute by selection of a low gear may be most suitable for timely application of irrigation water to a field.

Staying with FIG. 11C, adoption of variable speed drive motors and motor controllers 21 for the above example, as herein disclosed as conventional irrigation systems, may enable even slower paces of movement for a drive tower structure 3 with a transfer case 54 configured to operate in a low-gear reduction ratio. For example, the RPM of a drive motor and motor controller 21 may be slowed from the 1,800 RPM, used in the above low-gear example, to 900 RPM. This may result in a movement at an outermost drive tower structure 3 of just 2.0 feet per minute (900 RPM/6,250 reduction)=0.144 RPM at a drive wheel assembly 7,8. Such wheel 7,8 with a circumference of 14.4 feet may result in a pace of movement of only 2.1 feet per minute as follows: (14.4×0.144)=2.1 feet per minute. Using the above example, for the irrigation system 1 with a circumference of 7,916 feet, the pace of 2.1 feet per minute would result in a single irrigation pass of (7,916 feet/2.1 feet per minute)=3,770 minutes or 63 hours. Staying with the example of a pumping rate of 800 gallons per minute, the rate used in the above examples, such an irrigation pass would result in the following acre inches of application of water to the entire field: (800 GPM×3,770 minutes)/120 acres/27,154 gallons per acre inch)=0.93 acre inches.

Such paces of movement of 4.19 feet per minute and 2.1 feet per minute, may include the selection of a low-gear in a transfer case 54 and with the selection being combined with the use of variable-speed drive motors and motor controller 21, may not be a suitable for the application of crop inputs. If the low-gear pace of movement were selected for a single pass, the resulting amount of irrigation water applied to a field may dilute the crop nutrient application with too much water: (1,894 minutes×800 gallons per minute/120 acres/27,154 gallons per acre inch)=0.47 acre inches or with the drive motor and motor controller 21 RPM at 900 RPM, (3,770 minutes×800 gallons per minute/120 acres/27,154 gallons per acre inch)=0.93 acre inches. Such copious applications of irrigation water may not be conducive to the efficacy of chemicals, thereby, applied to a growing crop. However, such a speed of movement provided by the selection of a low-gear reduction ratio in a transfer case 54 may be optimum for applying irrigation water at rates in the above example of 0.47 inches to 0.93 inches.

By the respective selection of a low-gear reduction ratio and a high-gear reduction ratio to match either an irrigation application (low-gear) or a chemical application (high-gear), some embodiments may provide irrigation system 1 operators with a means to maintain drive motor and motor controller 21 RPM at more optimum levels. Such optimum levels of RPM may generally result in drive motors and motor controllers 21 delivering relatively more torque output than would result from operating drive motors and motor controllers 21 using just conventional variable-speed motors.

In either the selection of a high-gear reduction ratio (illustrated in FIG. 11A) or the selection of a low-gear reduction ratio (illustrated in FIG. 11C), the transfer case output shaft 70 is configured to propel an inline first sun/planet gear cage with shafts 37 of inline wheel-drive gearbox 11 (the gearbox detail shown only in FIG. 8A). The gear cage with shafts 37 in turn is configured to propel additional inline sun/planet gear cages 38,39,40 of inline wheel-drive gearbox 11 as similarly shown in FIG. 8A. A final splined output shaft 69 may be propelled by the final sun/planet gear cage which in the example is the inline fourth sun/planet gear cage with shafts 40 of inline wheel-drive gearbox 11. In turn the final splined output shaft 69, supported by the built-in, wheel hub housing 17 positioned at a distal end 6 of the universal inline drive mount adapter with wheel-hub housing 50 (as shown in FIG. 8F), may propel a wheel mount hub with studs and bolts 53, the wheel mount hub 53 may be characterized as attaching to a corresponding drive wheel assembly 7,8 (as shown in FIG. 8D) to propel the drive tower structure 3 over the ground.

Referring to FIG. 11B, the transfer case 54 may characterized as being configured with a neutral gear. Selection of the neutral gear include moving the shift changing fork and mechanism 35 to align the shift changing fork indicator 74 with the marker “N” of gear selection indicator 59 in transfer case 54. With the neutral gear selected, the transfer case output shaft 70 may not be driven by either the splined gear large 66 or splined gear small 65, the selection may include the dog teeth windows 75 of both the free-wheeling gear-large 62 and the free-wheeling gear-small 63 not being locked-in (engaged) with the corresponding dog teeth 76 of sliding splined dog gear 73. In other words, even with drive motor and motor controller 21 being powered on with the motor shaft 60 and splined motor shaft gear 61 rotating, the final splined output shaft 70 may not be rotating.

With reference to FIG. 11B, with the neutral gear selected, the drive wheel assemblies 7,8, connected to an opposite end of a corresponding final splined output shaft 69, would be free-wheeling, e.g., with supply power discontinued and the motor brake 12 engaged, wheel assemblies 7,8 would be free-wheeling. Such a configuration may include the transfer case output shaft 70 not being connected to the motor shaft 60 of drive motor and motor controller 21, the motor shaft 60 being held by the engaged drive motor brake 12. As disclosed above and with reference to U.S. Pat. No. 3,817,455 by Cornelius, cited above, selection of the neutral gear with the power supply discontinued to the drive motor and motor controller 21 and the corresponding motor brake 12 engaged, the corresponding drive tower structures 3 of an irrigation system 1 may be configured to be towable, with the wheel assemblies 7,8 free to turn and unaffected by the engaged motor brake 12.

The neutral-gear selection for all intermediate drive tower structures 3 may also enable a last drive tower structure 3 to be configured to either the low-gear or the high-gear and configured with a mobile supply power source such as a portable generator (not shown), to pull the plurality of the intermediate drive tower structures 3 for the purpose of relocating the irrigation system 1 to a new location, such as to position irrigation system 1 to be operated in an adjacent field. By configuring each wheel assembly with an inline wheel-drive gearmotor assembly with transfer case 57 and by the use of variable-speed drive motors and motor controllers 21, each of the dual outermost drive motors and motor controllers may be configured to operate at variable speeds, the variable speeds being further configured to be discretely applied by an operator to each drive motor and motor controller to provide a discrete speed of rotation to each corresponding final splined output shaft to, thereby, skid-steer the outer most drive tower structure when being towed by varying the corresponding pace of movement over the ground of each drive wheel assembly, making the movement of the entire irrigation system steerable.

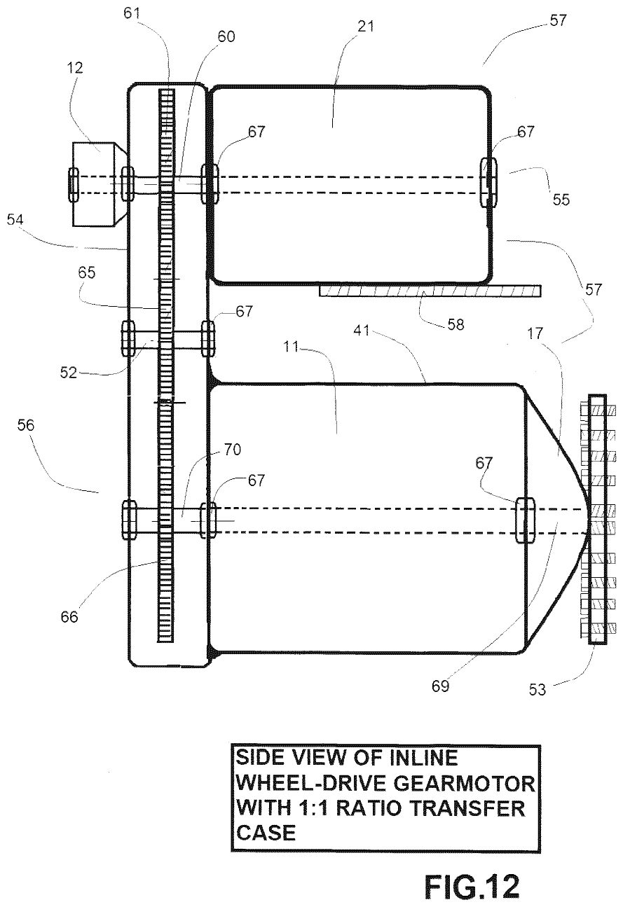

Referring to FIG. 12, an inline wheel-drive gearmotor assembly with transfer case 57, an alternate configuration may have a fixed gear reduction ratio rather than selectable gear reduction ratios. Shown in FIG. 12 is the gearmotor assembly 57 with a fixed gear reduction ratio of 1:1. The gear reduction ratio configured for a fixed gear reduction transfer case 54 may be any gear reduction ratio required for an application, but only one fixed-gear reduction ratio. In an example embodiment, the transfer case 54 may be configured with two or more selectable gear reduction ratios and a neutral gear as illustrated in FIGS. 11A, 11B, and 11C.

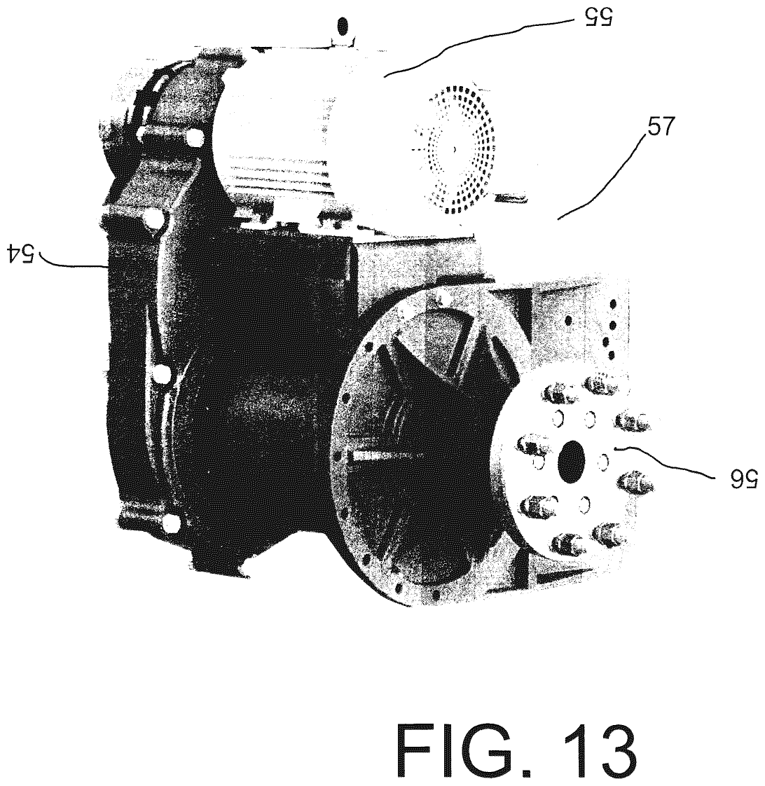

Referring to FIG. 13, a complete inline wheel-drive gearmotor assembly with transfer case 57 is shown and the complete gearmotor assembly 57 may be characterized as being configured with a top separated parallel section of an inline wheel-drive gearmotor assembly with motor controller 55, a bottom separated parallel section of an inline wheel-drive gearmotor assembly 56, the top and bottom assemblies 55,56 being connected by a transfer case 54, the transfer case 54 having two or more selectable gear reduction ratios and a neutral gear selection.

In North America there may be an installed base of approximately 300,000 legacy irrigation systems 1; world-wide there may be over 500,000. In some example embodiments, the installation of inline wheel-drive gearmotor assemblies with transfer case 57 onto the broad base of existing irrigation systems 1, the gearmotor assemblies 57 that may be configured with selectable gear reduction ratios and a neutral gear selection, as shown in FIGS. 11A, 11B, and 11C, and combined with corresponding variable-speed drive motors and motor controller 21 (of conventional irrigation systems) may significantly broaden the functionality of the base of legacy irrigation systems 1. This in turn may enable application of crop inputs not practical or feasible when using the slower moving, legacy right-angle wheel-drive gearboxes 25,33 with the center drive motor with gearbox 23. For example, application of chemicals through a legacy irrigation system 1 to a crop foliage canopy by injection of chemicals into the irrigation water supply may be too dilute, e.g., application of too much water and too little chemical, to effectively treat the above ground crop canopy. The relatively slow, maximum pace of movement of legacy irrigation systems 1 may result in excess irrigation water that may simply wash away to the ground the prescribed chemical, rather than remaining where needed—on the crop foliage canopy. Reconfiguring the base of irrigation systems 1 with inline wheel-drive gearmotor assemblies with transfer case 57 may be characterized as being configured to selectively enable a much faster pace of movement for the irrigation system 1, as illustrated by the selective positioning of the shift changing fork and mechanism 35 as illustrated in FIG. 11A, and, thereby, may mitigate the chemical dilution issue, increasing the efficacy of certain crop inputs.

With a selectable high-gear reduction ratio for a faster pace of movement for an irrigation system 1, facilitated by reconfiguring the base of irrigation systems 1 with some embodiments (e.g., both the universal Inline drive mount adapter with wheel-hub housing 50 and the inline wheel-drive gearmotor assemblies with transfer case 57), the reconfigured irrigation systems 1 may also be configured with an auxiliary set of spray nozzles (not shown). Such an axillary set of spray nozzle may be further characterized as being configured for the application of liquid crop inputs using a chemical injection apparatus configured to discretely apply liquid crop input solutions with or without simultaneous application of irrigation water and do so with a much faster pace of movement for irrigation system 1. Such a spray nozzle set configured for use with a chemical injection apparatus (not shown) on an irrigation system 1 may also be capable of sight-specific application of crop inputs, the sight specific features disclosed in U.S. Provisional Patent Application No. 63/119,994 and U.S. Provisional Patent Application No. 63/120,004, both filed Dec. 1, 2020.

Furthermore, with a much faster pace of movement for an irrigation system 1, facilitated by selection of a high-gear reduction ratio, configured by movement of shift changing fork indicator 74 of the shift changing fork and mechanism 35 to the position illustrated in FIG. 11A, the reconfigured irrigation systems 1 may be fitted with a plethora of auxiliary sensors and cameras (not shown) suitable for frequent and timely collection of sight-specific, geo located data on field and growing crop conditions. Such collected data may be used to create prescriptions for sight-specific field treatment of insects, pathogens, nutrient deficiencies, and the like. The delivery of such prescriptive treatments through an irrigation system 1 may be further facilitated by a steady pace of movement using variable-speed drive motors and motor controllers 21 compared to using fixed-speed drive motors and motor controllers 21 with on/off cycling of the legacy center drive motors with gearbox (both fixed-speed and variable-speed drive motors and motor controller 21 of conventional irrigation systems). The faster paces of movement over the ground, with or without application of irrigation water, may be made most feasible by simultaneous adoption of both variable-speed drive motors and motor controllers 21 of conventional irrigation systems and the inline wheel-drive gearmotor assemblies with transfer case 57 of some embodiments.

Example embodiments, disclosed herein, do not limit the invention; and alternative embodiments are recognized by the inventors. For example, the universal drive mount adapter 4, 50, in some embodiments, may be attached to a drive beam 14 using ring clamps around the drive beam 14 or by welding in-lieu-of using the legacy right-angle wheel-drive gearbox mounts 32 as illustrated in the accompanying drawings.

In yet another embodiment, the drive beam 14 may be fabricated with built-in universal drive mount adaptors 4,50 as a feature of a complete drive beam 14. The built-in inline drive mount adapters 4,50, as a component of a complete drive beam 14, may be welded to or mechanically attached to the drive beam 14. Such drive beams 14 featuring built-in universal drive mount adaptors 4,50 may be provided on new irrigation systems 1 by manufacturers or provided for retrofit by the manufacturers to existing irrigation systems 1. In another embodiment, for such an OEM retrofit, the entire drive beam 14 of a legacy irrigation system 1 may be replaced with an alternative built-in drive beam 14 that includes the features of universal drive mount adaptors 4,50 as herein disclosed.

One embodiment includes an irrigation system. The irrigation system may include a plurality of drive tower structures each including a drive beam configured with left right-angle wheel-drive gearbox mounts and right, right-angle wheel-drive gearbox mounts, each of the mounts configured with a plurality of bolt holes for attaching a corresponding legacy right-angle wheel-drive gearbox to the mount. The irrigation system may also include the bolt holes being alternatively suitable for attaching a universal inline drive mount adapter configured with bolt holes at a first end of the adapter that correspond to bolt holes in the gearbox mounts, each the adapter further configured with bolt holes at a distal end suitable for attaching an inline wheel-drive gearmotor assembly with transfer case.

Multiple modifications and variations may be possible considering the above teachings. The invention may be practiced otherwise than as specifically described within the scope of the appended claims, wherein that which is prior art is antecedent to the novelty set forth in the “characterized by” clauses of the following claims. The novelty is meant to be particularly and distinctly recited in the “characterized by” clauses whereas the antecedent recitations merely set forth the old and well-known combinations of prior art in which the invention resides. These antecedent recitations should be interpreted to cover any combination in which the inventive novelty exercises its utility. In addition, the reference numerals in the claims are merely for convenience and are not to be read in any way as limiting.

One or more elements or aspects or steps, or any portion(s) thereof, from one or more of any of the systems and methods described herein may be combined with one or more elements or aspects or steps, or any portion(s) thereof, from one or more of any of the other systems and methods described herein and combinations thereof, to form one or more additional implementations and/or claims of the present disclosure. Furthermore, one or more elements or aspects or steps, or any portion(s) thereof, from one or more of any of the systems and methods described herein may form another embodiment of the systems and methods described herein.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An irrigation system having a movement direction over a ground surface of a field, the irrigation system comprising:
plurality of pipe spans, each having a longitudinal axis, the plurality of pipe spans each connected at a flex joint that provides fluid connection between a distal end of a span pipe and a first end of a span pipe of adjacent pipe spans, the pipe spans making up a linear length of the irrigation system as the irrigation system rotates about the field in a forward movement direction or reverse movement direction;
a plurality of drive tower structures each supporting and moving a corresponding pipe span, each of the drive tower structures including a drive beam to which an operable set of driveline components are mounted and functional with the driveline components including a motor drop cable providing supply power from a corresponding tower control box to a center drive motor with gearbox, with the center drive motor with gearbox linked by couplers and driveshafts to one or more right-angle wheel-drive gearboxes attached to legacy right-angle wheel-drive gearbox mounts of a drive beam and with an output shaft of the gearboxes connecting to and supporting corresponding wheel mount hubs with studs and bolts, the wheel mount hubs configured for attaching corresponding drive wheel assemblies to a corresponding drive tower structure to support and propel the drive tower structures over the ground surface;
the irrigation system assembled by removal of the legacy right-angle wheel-drive gearboxes at corresponding drive tower structures and wherein the drive tower structures each being reconfigured by mounting of universal inline drive mount adapters each of the adapters being mechanically attached at a first end to a corresponding wheel-drive gearbox mount of a drive beam of a corresponding drive tower structure, the mechanical attachment of the adapter configured by using universal wheel-drive gearbox mounting holes and universal wheel-drive gearbox attaching bolts, the holes conventionally configured into the legacy right-angle wheel-drive gearbox mounts and, a matching set of holes configured into the first end of a universal inline drive mount adapter;
each universal drive mount adapter including a built-in, wheel-hub housing at a distal end, the housing being configured into the adapter by casting or forging the housing with each universal inline drive mount adapter with wheel-hub housing without using bolts;
each built-in, wheel-hub housing configured with a circular depression positioned at a distal end of the adapter, the circular depression configured to position and support a circular, inline gearbox housing with ring gear of an inline wheel drive gearbox of a bottom separated parallel section of an inline wheel-drive gearmotor assembly, a bottom gearmotor assembly being configured with a corresponding top separated parallel section of an inline wheel-drive gearmotor assembly with motor controller, corresponding top and bottom parallel sections of the gearmotor assembly being configured with a transfer case, the transfer case configured to connect the top parallel section with the bottom parallel section to thereby configure a complete inline wheel-drive gearmotor assembly with transfer case;
an inline motor mount, being configured to receive, position and support the drive motor and motor controller of a corresponding top separated parallel section of an inline wheel-drive gearmotor assembly, the mount being configured to be attached to the distal end of the adapter, a resulting position of the gearmotor assembly with transfer case being configured into a vertical space from below a plane of the bottom of the drive beam to the vertical space above a plane of the top of the drive beam and being configured at a position outboard of the respective end of the drive beam;
each wheel-hub housing of each universal inline drive mount adapter with wheel-hub housing being configured to position and support a final splined output shaft, the output shaft being connected at a splined end to a fourth or final-gear main drive of an inline wheel-drive gearbox, the gearbox being configured as a component of the bottom parallel section of an inline wheel-drive gearmotor assembly, the gearbox being configured to be propelled by a transfer case output shaft of the transfer case, the output shaft being configured to propel an inline first sun/planet gear cage with shafts of the gearbox, the first gear cage in turn configured to propel an inline second sun/planet gear cage with shafts of the gearbox, the second gear cage in turn configured to propel an inline third sun/planet gear cage with shafts, the third gear cage in turn configured to propel an inline fourth sun/planet gear cage with shafts, the fourth gear cage in turn configured to connect to the splined end of the final splined output shaft of the wheel-hub housing and thereby propel the output shaft;
each final splined output shaft being configured, at an opposite end to the splined end, with a wheel mount hub with studs and bolts, the hub configured for the mounting of a corresponding drive wheel assembly of a corresponding drive tower structure; and
each transfer case of the inline wheel-drive gearmotor assembly with transfer case being configured with two or more selectable gear reduction ratios, such gear reduction ratios being selectable by movement of a shift changing fork to configure a sliding splined dog gear from a neutral position to a position wherein dog teeth of the sliding splined dog gear engage with a corresponding dog teeth window of an adjacent free-wheeling gear-large or with an adjacent free-wheeling gear-small, to thereby achieve one of two or more selectable gear reduction ratios between a rotating motor shaft and splined motor shaft gear of the top separated parallel section of an inline wheel-drive gearmotor assembly with controller and a rotating transfer case output shaft, the output shaft in turn propelling an inline first sun/planet gear cage with shafts of a corresponding inline wheel-drive gearbox of the bottom separated parallel section of an inline gearmotor assembly.

2. The system as set forth in claim 1, wherein corresponding drive wheel assemblies, one left and one right, are each characterized as being attached to a corresponding wheel mount hub with studs and bolts of a universal inline drive mount adapter with wheel-hub housing, each wheel mount hub configured at a distal end of a corresponding universal inline drive mount adapter with wheel-hub housing to, thereby, propel the plurality of drive tower structures of the irrigation system over the ground.

3. The system as set forth in claim 1, wherein each corresponding inline wheel-drive gearmotor assembly with transfer case and a corresponding center line of each drive wheel assembly being positioned outboard of the corresponding ends of a drive beam of a tower structure.

4. The system as set forth in claim 1, wherein the universal inline drive mount adapters are not requiring a use of couplers, driveshafts, and right angle gear reducers and by not requiring modification of drive beams of the drive tower structures of existing irrigation systems.

5. The system as set forth in claim 1, wherein the universal inline drive mount adapters being configured without changing the lateral position of corresponding drive wheel assemblies onto the ground in relationship to a wheel track established by the wheel assemblies when previously attached to the legacy right-angle wheel-drive gearboxes that have been removed to accommodate use of one of various embodiments described herein.

6. The system as set forth in claim 1, wherein the universal inline drive mount adapters being configured without changing a height of the drive beam above the ground surface.

7. The system as set forth in claim 1, wherein the universal inline drive mount adapters are fabricated from steel plate and reinforced with gussets and braces.

8. The system as set forth in claim 1, wherein the universal inline drive mount adapters are configured at a distal end with a circular hole, the hole configured to receive, position, and support a circular inline gearbox housing with ring gear, the housing being configured as a component of a corresponding bottom separated parallel section of an inline wheel-drive gearmotor assembly, the bottom section being configured with a top separated parallel section of an inline wheel-drive gearmotor assembly, the top and bottom parallel sections of the gearmotor assembly being configured with a transfer case, the transfer case configured to connect the top parallel section with the bottom parallel section to thereby configure a complete inline wheel-drive gearmotor assembly with transfer case, another example embodiment.

9. The system as set forth in claim 1, wherein the universal inline drive mount adapters are fabricated from metal castings or forgings reinforced with gussets or braces and with each casted or forged adapter including a wheel-hub housing casted with a circular depression at a distal end configured to receive the circular inline gearbox housing with ring gear.

10. The system as set forth in claim 1, wherein a first end of a corresponding universal inline drive mount adapter configured with a pattern of matching universal wheel-drive gearbox mounting holes, the universal inline drive mount adapters characterized as having the pattern of matching mounting holes symmetrically configured to facilitate mounting of the adapters to either a left or a right legacy right-angle wheel-drive gearbox mount of a drive beam by simply rotating the universal adapter by 180 degrees.

11. The system as set forth in claim 1, wherein the universal inline drive mount adapters are attached by means of welding onto a drive tower structure.

12. The system as set forth in claim 1, wherein the universal inline drive mount adapters are attached using one or more clamps connecting the adapter to a drive beam.

13. The system as set forth in claim 1, wherein the universal inline drive mount adapters are attached to other structural members of corresponding drive tower structures and not to the drive beams of the drive tower structures.

14. The system as set forth in claim 1, wherein each corresponding drive motor and motor controller is connected to supply power from a tower box being configured to provide operating control at a corresponding drive tower structure using a corresponding first cable and second cable of a dual motor drop cable to supply discrete control and power to each corresponding drive motor and motor controller.

15. The system as set forth in claim 1, wherein the movement of the shift changing fork and mechanism to engage the corresponding dog teeth configured on a first side and on a second side of the sliding splined dog gear with the corresponding dog windows configured on the adjacent free-wheeling gear-large and the free-wheeling gear-small, to thereby select a high-gear reduction ratio, a low-gear reduction ratio, or a neutral-gear with the neutral-gear selection, wherein the dog teeth not engaging a dog window, the shift changing fork and mechanism being characterized as being configured to be moved manually by an operator.

16. The system as set forth in claim 1, wherein the movement of the shift changing fork and mechanism to engage the corresponding dog teeth configured either on a first side or on a second side of the sliding splined dog gear with the corresponding dog windows configured on the free-wheeling gear-large and the free-wheeling gear-small, with the neutral gear selection, wherein the dog teeth not engaging a dog window, to thereby select a high-gear reduction ratio, a low-gear reduction ratio, or a neutral-gear being controlled remotely based on signals sent to an electronic, hydraulic, or pneumatic actuator, the actuator configured to move the shift changing fork and mechanism.

17. An irrigation system having a movement direction over a ground surface of a field, the irrigation system comprising:
a plurality of pipe spans, each having a longitudinal axis, the plurality of pipe spans each connected at a flex joint that provides fluid connection between a span pipe distal end and a span pipe first end of adjacent pipe spans, the pipe spans making up a linear length of the irrigation system as it rotates about the field in a forward or reverse movement direction;
a plurality of drive tower structures each supporting and moving a corresponding pipe span, each drive tower structure including a drive beam to which an operable set of driveline components are mounted and functional with the driveline components including a motor drop cable providing supply power from a corresponding tower control box to a center drive motor with gearbox, with the center drive motor with gearbox linked by couplers and driveshafts to one or more right-angle wheel-drive gearboxes attached to legacy right-angle wheel-drive gearbox mounts of a drive beam and with output shafts of the gearboxes connecting to and supporting corresponding wheel mount hubs with studs and bolts, the wheel mount hubs configured for attaching corresponding drive wheel assemblies to a corresponding drive tower structure to support and propel the drive tower structures over the ground surface;
the irrigation system assembled by removal of the legacy right-angle wheel-drive gearboxes at corresponding drive tower structures, wherein the drive tower structures each being reconfigured by a mounting of universal inline drive mount adapters, an example embodiment, each adapter being mechanically attached at a first end to a corresponding wheel-drive gearbox mount of a drive beam of a corresponding drive tower structure, the mechanical attachment of the adapter configured by using universal wheel-drive gearbox mounting holes and universal wheel-drive gearbox attaching bolts, the holes conventionally configured into the legacy right-angle wheel-drive gearbox mounts and a matching set of holes are in a first end of a universal inline drive mount adapter;
each legacy right-angle wheel-drive gearbox mount of each drive tower structure are configured to rotate ninety degrees from a position of the drive wheel assemblies required for operating the irrigation system in a field, a ninety-degree rotation, thereby, configuring each drive wheel assembly to align with all drive wheel assemblies for a purpose of towing the irrigation system, the towing facilitated by pulling the irrigation system from either a center pivot tower or the outermost drive tower structure;
each universal drive mount adapter including a built-in, wheel-hub housing at a distal end, the housing configured with the adapter by casting or forging the housing with each universal inline drive mount adapter with wheel-hub housing without using bolts;
each built-in, wheel-hub housing being configured with a circular depression positioned at a distal end of the adapter, the circular depression being configured to position and support an inline gearbox housing with ring gear of an inline wheel drive gearbox of a bottom separated parallel section of an inline wheel-drive gearmotor assembly, a bottom gearmotor assembly being configured with a corresponding top separated parallel section of an inline wheel-drive gearmotor assembly, a corresponding top and a corresponding bottom parallel sections of the gearmotor assembly being configured with a transfer case, the transfer case being configured to connect the top parallel section with the bottom parallel section to thereby configure a complete inline wheel-drive gearmotor assembly with transfer case, another example embodiment;
an inline motor mount, configured to position and support the drive motor and motor controller of a corresponding top separated parallel section of an inline wheel-drive gearmotor assembly, the mount being configured to be attached to the distal end of the adapter, a resulting position of the gearmotor assembly with transfer case being configured into a vertical space from below a plane of the bottom of the drive beam to the vertical space above the plane of the top of the drive beam and being configured at a position outboard of the respective end of the drive beam;
each wheel-hub housing of each universal inline drive mount adapter with wheel-hub housing being configured to position and support a final splined output shaft, the output shaft being connected at a splined end to a fourth gear-main drive of an inline wheel-drive gearbox, the gearbox being configured as a component of the bottom parallel section of an inline wheel-drive gearmotor assembly, the gearbox being configured to be propelled by a transfer case output shaft of the transfer case, the output shaft being configured to propel an inline first sun/planet gear cage with shafts of the gearbox, the first gear cage in turn configured to propel an inline second sun/planet gear cage with shafts of the gearbox, the second gear cage in turn configured to propel an inline third sun/planet gear cage with shafts, the third gear cage in turn configured to propel an inline fourth sun/planet gear cage with shafts, the fourth gear cage in turn configured to connect to the splined end of the final splined output shaft of the wheel-hub housing and thereby propel the output shaft;
each final splined output shaft being configured, at an opposite end to the splined end, with a wheel mount hub with studs and bolts, the hub configured for the mounting of a corresponding drive wheel assembly of a corresponding drive tower structure; and
each transfer case of the inline wheel-drive gearmotor assembly with transfer being configured with two or more selectable gear reduction ratios, such gear reduction ratios being selectable by movement of a shift changing fork to configure a sliding splined dog gear from a neutral position to a position that engages either a free-wheeling gear-large or a free-wheeling gear-small, to thereby achieve one of two or more selectable gear reduction ratios between a rotating motor shaft and splined motor shaft gear of the top separated parallel section of an inline wheel-drive gearmotor assembly with controller and a rotating transfer case output shaft, the output shaft in turn propelling an inline first sun/planet gear cage with shafts of a corresponding inline wheel-drive gearbox of the bottom separated parallel section of an inline gearmotor assembly.

18. The system as set forth in claim 17, further configured for towing, each transfer case of each inline wheel-drive gearmotor assembly with transfer case at each corresponding intermediate drive tower structure being towable by the movement of a corresponding shift changing fork to align a corresponding shift changing fork indicator with a neutral setting, the setting indicated by a marker “N” on a gear selector indicator visible on the transfer case.

19. The system as set forth in claim 17, further configured for towing, a corresponding transfer cases of the inline wheel-drive gearmotor assemblies with transfer case at the outermost drive tower structure may each be characterized as being configured to tow the corresponding, free-wheeling intermediate tower structures, a towing capability generated, at least in part, by configuring two inline wheel-drive gearmotor assemblies at the outermost tower structure to be in either a high gear reduction ratio or a low gear reduction ratio, the reduction ratios for towing enabled by the movement of a corresponding shift changing fork and mechanism to align a shift changing fork indicator with a gear selection indicator and the movement of the shift changing fork and mechanism also engaging a sliding splined dog gear with either a free-wheeling gear-large or a free-wheeling gear-small, the alignment and movement corresponding either to a low-gear or to a high-gear, but not neutral, the alignment indicated by a marker of either “H” for the high-gear setting or “L” for the low-gear setting, the marker visible on the gear selection indicator of the transfer case;
a supply power, such as a portable generator, may provide power to the outermost drive tower, the corresponding transfer cases being configured with either a low-gear setting or a high-gear setting;
the outermost inline wheel-drive gearmotor assemblies, left and right, having a source of power to operate the gearmotor assemblies and, thereby, tow a plurality of intermediate drive tower structures as they follow the powered on outermost drive tower structure to move the irrigation system to an alternative location; and
wherein each of the outermost drive motors and motor controllers being configured to operate at variable speeds, the variable speeds being further configured to be discretely applied to each drive motor and motor controller to provide a discrete speed of rotation to each corresponding final splined output shaft to, thereby, skid-steer an outer most drive tower structure by varying a corresponding pace of movement over a ground of each drive wheel assembly, making the movement of an entire irrigation system steerable.

20. An irrigation system comprising:
a plurality of drive tower structures each including a drive beam configured with left right-angle wheel-drive gearbox mounts and right, right-angle wheel-drive gearbox mounts, each of the mounts configured with a plurality of bolt holes for attaching a corresponding legacy right-angle wheel-drive gearbox to the mount; and
the bolt holes being alternatively suitable for attaching a universal inline drive mount adapter configured with bolt holes at a first end of the adapter that correspond to bolt holes in the gearbox mounts, each the adapter further configured with bolt holes at a distal end suitable for attaching an inline wheel-drive gearmotor assembly with transfer case.
